(19) United States
(12) Patent Application Publication
(10) Pub. No.: US 2021/0273807 A1
(43) Pub. Date: Sep. 2, 2021

(54) SCALING AND ACCELERATING DECENTRALIZED EXECUTION OF TRANSACTIONS

(71) Applicants: Oded WERTHEIM, Tel Aviv (IL); Tal Shalom KOL, Tel Aviv (IL); Oded NOAM, Tel Aviv (IL); Ori ROTTENSTREICH, Tel Aviv (IL); Maya LESHKOWITZ, Tel Aviv (IL)

(72) Inventors: Oded WERTHEIM, Tel Aviv (IL); Tal Shalom KOL, Tel Aviv (IL); Oded NOAM, Tel Aviv (IL); Ori ROTTENSTREICH, Tel Aviv (IL); Maya LESHKOWITZ, Tel Aviv (IL)

(21) Appl. No.: 17/265,194

(22) PCT Filed: Jul. 31, 2019
(86) PCT No.: PCT/US2019/044568

§ 371 Date: Feb. 1, 2021

Related U.S. Application Data
(60) Provisional application No. 62/712,951, filed on Jul. 31, 2018.
(60) Provisional application No. 62/712,966, filed on Jul. 31, 2018.

(51) Int. Cl. H04L 9/32; H04L 9/06; G06F 9/46

(52) U.S. Cl. CPC H04L 9/3221; H04L 2209/38; G06F 9/466; H04L 9/0643

(57) ABSTRACT

Systems and methods are disclosed for scaling and accelerating decentralized execution of transactions. In one implementation, transactions are divided into transaction segments. A first transaction segment is executed and relevant initialization state for the first transaction segment is determined. A second transaction segment is executed based on the execution of the first transaction segment. Based on the execution of the second transaction segment and an output of the execution of the first transaction segment, a In second initialization state is determined. The first transaction segment and the first initialization state are provided to a first execution shard. The second transaction segment and the second initialization state are provided to a second execution shard. A validation of result(s) of the transactions is received. The validation is computed based an output of the execution of the first transaction segment and an output of the execution of the second transaction segment.

### CROSS-REFERENCE TO RELATED APPLICATIONS

This application is related to and claims the benefit of priority to U.S. Patent Application No. 62/712,951, filed Jul. 31, 2018, and U.S. Patent Application No. 62/712,966, filed Jul. 31, 2018, each of which is incorporated herein by reference in its respective entirety.

### TECHNICAL FIELD

Aspects and implementations of the present disclosure relate to data processing and, more specifically, but without limitation, to scaling and accelerating decentralized execution of transactions.

### BACKGROUND

Data/records can be stored on a decentralized or distributed ledger such as blockchain that is synchronized across multiple computing/storage devices. Various cryptographic techniques can be utilized to secure such records.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A illustrates an example system, in accordance with an example embodiment.

FIG. 1B illustrates further aspects of an example system, in accordance with an example embodiment.

FIG. 1C illustrates example scenario(s) described herein, according to example embodiments.

FIG. 2 illustrates example scenario(s) described herein, according to example embodiments.

FIG. 3 illustrates example scenario(s) described herein, according to example embodiments.

FIG. 4 illustrates example scenario(s) described herein, according to example embodiments.

FIG. 5 illustrates example scenario(s) described herein, according to example embodiments.

FIG. 6 illustrates example scenario(s) described herein, according to example embodiments.

FIG. 7 is a flow chart illustrating aspects of a method for scaling and accelerating decentralized execution of transactions, in accordance with an example embodiment.

FIG. 8 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to accelerating decentralized execution of transactions. In certain implementations, the described technologies are directed to accelerating decentralized execution of blockchain transactions towards centralized performance.

An example environment is depicted and described herein. In certain implementations, the described technologies can be implemented in conjunction with various nodes and users. For example, an example system can include a decentralized or distributed leger such as a blockchain that can be distributed/stored across multiple connected nodes. Examples of such nodes are depicted and described herein. As described herein, consensus algorithm(s) can be applied in relation to the referenced nodes. Such nodes may be employed in a permissioned or permissionless environment (e.g., using algorithms such as proof-of-stake or delegated proofof-stake to map the nodes that participate in the protocol).

The referenced nodes can be computing devices, storage devices, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device). Such a private key can be a cryptographic key (e.g., a string of bits used by a cryptographic algorithm to transform plain text into cipher text or vice versa) that may be kept secret by a party and used to sign transactions (e.g., the transfer of a token to another user, server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s).

Adding completed blocks to the blockchain ledger forms a permanent public record of various included transactions. The blockchain ledger can be replicated and distributed across multiple nodes with hin the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction. In this scenario, a node that receives two separate chains that include blocks with transactions originating from the same token address will choose the longest chain, which should be associated with the first conducted transaction. In such a manner, the blockchain may be used to provide verification of various operations, transactions, etc.

Blockchain technologies can include various distributed tasks which consensus is reached for, including: ordering of transactions and execution of the ordered transactions. As described herein, a paradigm can be implemented in which the execution of transactions is separated from their ordering, e.g., to focus on or otherwise prioritize the execution task. To allow scalability, a distributed execution model in which network nodes interact with enhanced or stronger nodes (which may be referred to herein as “accelerator(s)”) can be utilized.

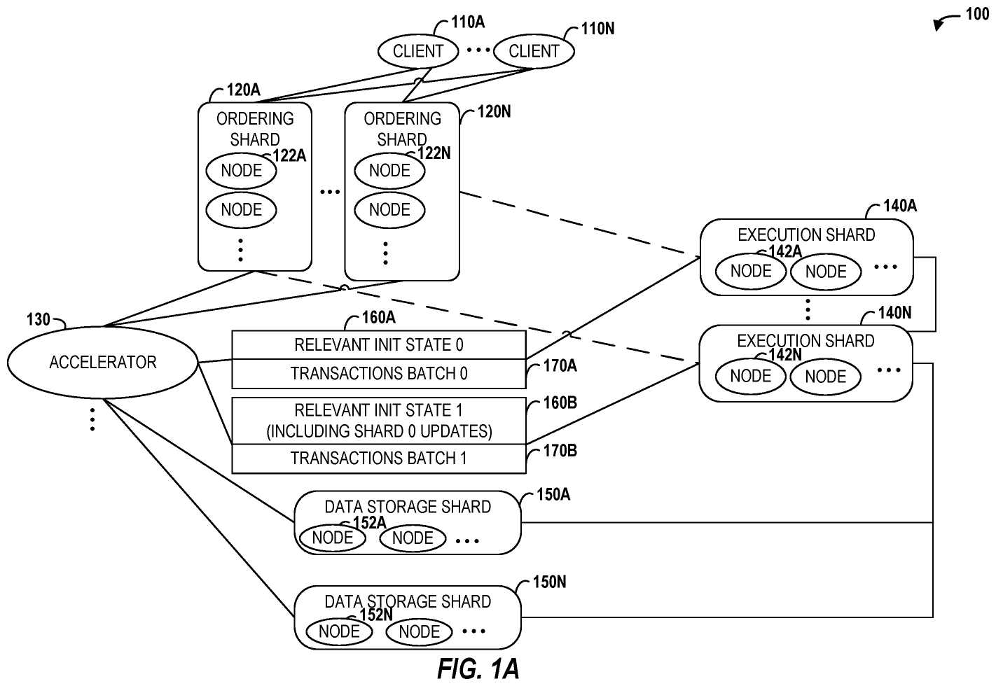

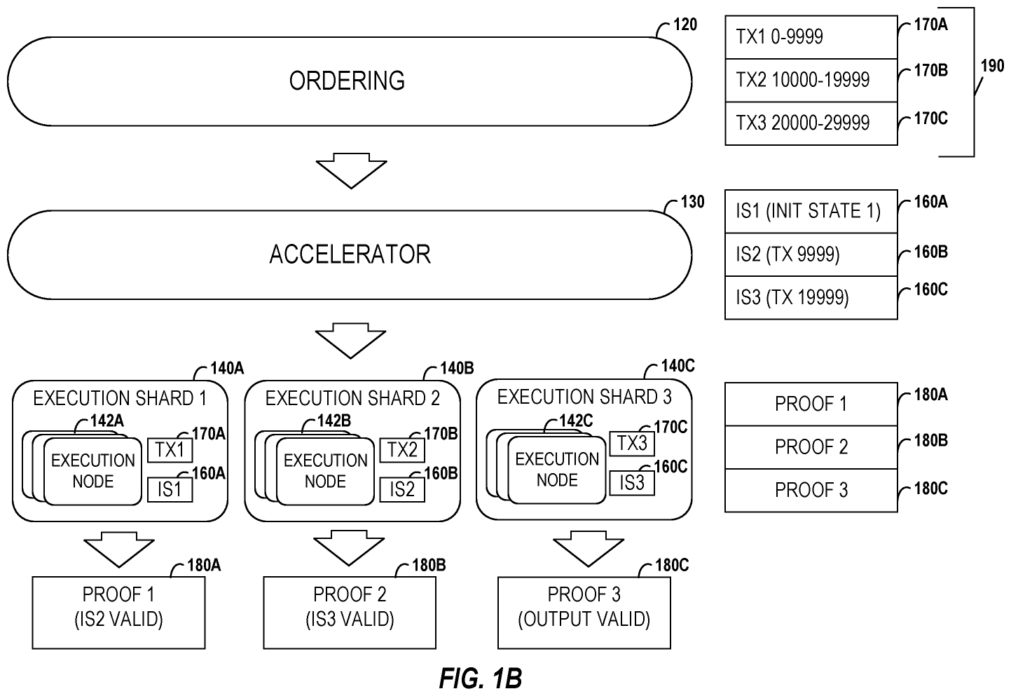

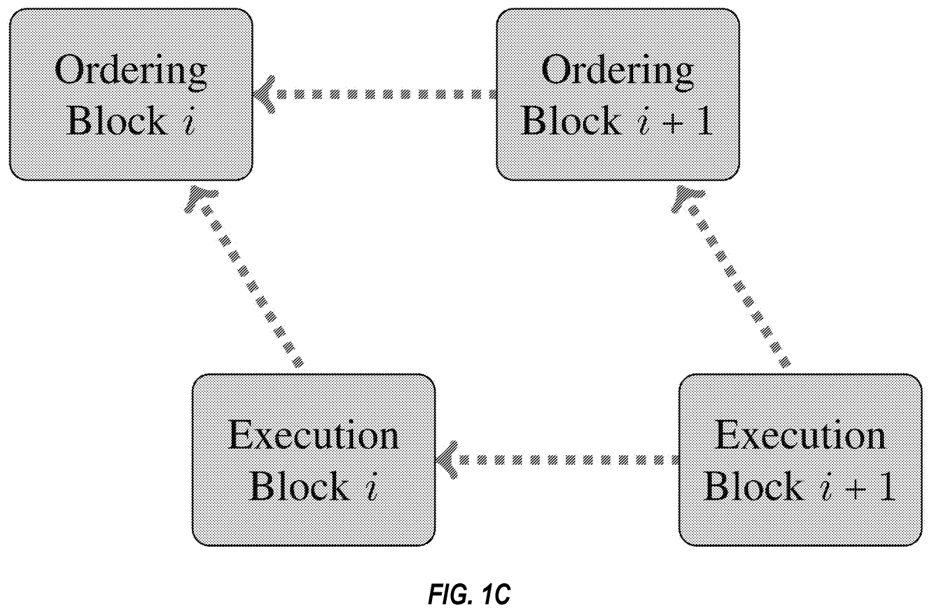

FIG. 1A depicts an example implementation of the described technologies. As shown in FIG. 1A, system 100 can include accelerator 130. As described herein, accelerator 130 can execute a block of transactions and provides ‘hints’ that allow other nodes/committees of nodes (e.g., execution shard(s) 140) to execute various segments of the block, e.g., in parallel. By way of further illustration, FIG. 1A depicts further aspects of the described technologies, such as block 190 of transactions, which is made up of transaction segments 170A, 170B, etc. The nodes/committees of nodes verify the execution performed by the accelerator together with the validity of the block partitioning to segments. In certain implementations, the described technologies can ensure or improve correctness of the execution as well as liveness, even when the accelerator or subset of the nodes are Byzantine. In doing so, the execution process can be improved or expedited while minimizing the amount of communication between various devices, nodes, entities, etc.

Technologies, such as those described herein (e.g., blockchain or other decentralized or distributed technologies), can involve tasks, operations, or processes including transaction ordering and transaction execution. In an example ordering process, nodes within a decentralized system or network (e.g., ordering shard(s) 120 which include nodes 122) reach consensus regarding the ordering of transactions. Examples of the transactions described herein can include but are not limited to payments/transactions between one node to another or may encompass broader functionality (e.g., smart contracts). The described transactions are ordered within a block, and blocks are appended to the chain, implying a full ordering on the transactions. The referenced transaction execution task(s)/operation(s) include but are not limited to computing the new state of the block which can be the outcome of executing the transactions in the block on the previous state. Such a state can contain data such as the balance of user account(s) and additional memory storage (e.g., for future transactions). Transaction execution also includes outputting the outcome of execution (also known as receipts).

In certain implementations, the referenced transaction ordering and execution tasks/operations can be coupled, e.g., by requiring execution of the new block to be performed by a block proposer. For example, in Ethereum, a new state can be computed by a miner as part of a newly proposed block. Nodes that receive a block proposal can accept it after re-executing and checking that the state was computed correctly. Such coupling of the referenced ordering and execution tasks may undermine efficiency, as these two processes can necessitate different resources with respect to storage, bandwidth, computation power, etc. As a result, they admit to different approaches for distributing and scaling.

Separating the described ordering and transaction execution operations can be advantageous for additional reasons. For example, certain advantages and efficiencies can be achieved with respect to scenarios in which consensus regarding the ordering is performed for encrypted transactions, e.g. to allow fairness and avoid censorship. In this case, the transaction execution cannot occur prior to decrypting (which is performed at the end of the ordering consensus process on the block) and hence ordering and execution must be performed consecutively. That is, while the execution of block i can only be done following its ordering, its execution can be done in parallel (or before) the ordering of a later block j for j>i.

As described herein, a decentralized system can be, for example, a system without a central control or ownership of the different devices, processing units, parties, entities, etc. participating in the computation. Moreover, some of the involved parties may operate in a Byzantine way. For correct operation of the overall system, it is assumed that some majority of parties follow a defined protocol. Due to the potential presence of Byzantine parties, distributing a task for parallel execution becomes complex and may require constant/ongoing verification of the operation and the communication among the different parties. Moreover, as parties may reside in different locations or regions, the communication among the parties may have high latency and be limited in bandwidth.

A distributed system can include one or more processing units that may span multiple cores in a processor or multiple servers in a datacenter. Unlike a decentralized system, the different components in a distributed system may operate under the same control. As such, components may trust others to operate as expected. As there may be no need to validate the operation of other components, methods such as speculative operation and roll-back may be easier to apply (as compared to a decentralized system). Moreover, the low latency and high bandwidth communication within a datacenter enables efficient parallel execution. The complexity of performing parallel execution and the high redundancy in resources invested in a decentralized system results in a limited ability to scale the overall system performance.

FIG. 1C is a diagram depicting dependencies between processes in an ordering-execution separated architecture as illustrated by the arrows. Transaction execution of block i is performed given the ordering of the transactions in block i, determined by an ordering service. Ordering of the next block i+1 is performed after the ordering of block i. The transaction execution of block i+1 depends on the execution of block i due to the effect on its initial state.

Parallel transactional execution is non trivial and, in certain implementations, may only be done to a limited extent due to limitations such as dependency between transactions. This challenge is compounded in execution of Turing complete code, where the state variables that are read in the execution can be modified during the execution, and thus cannot be determined in advance. Parallel execution in distributed systems can be achieved using various techniques such as Optimistic Concurrency Control (OCC), where transactions are executed in parallel assuming no interference among each other. When data conflicts are detected, the execution can be rolled-back and re-executed on a modified state. ‘Hints’ on the data accessed during the transaction execution can be used to reduce the probability for conflicts. Such hints can be generated, for example, based on a speculative execution of the transaction on an available previous version of the state. Alternatively, heuristics or hints may be generated and/or provided by the application being executed.

Certain blockchain decentralized architectures can be configured such that nodes validate by executing every block of transactions. In such architectures, increasing the network size does not increase the network capacity and the network scale is limited. Blockchain scalability can be addressed via various techniques using L2 (layer 2) network architecture, such as state channels or Plasma (e.g., as used for tokens or asset management applications). L2 networks are built on top of a main blockchain and can increase scalability by transitioning some of the state handling off-chain (or on a sidechain) while relying on the main chain for synchronization, security and dispute mediation. By allowing different off-chain instances to operate concurrently and independently, the overall network capacity increases. However, L2 architectures may require users to constantly monitor the relevant off-chain state in order and send a challenge to the main chain when an issue is detected, such as when a requirement does not fit many use cases. In addition, operations across different off-chain instances may be required to be handled by the main chain (thus creating a bottleneck).

Other architectures implement a sharding scheme to address network scalability. In these sharding schemes, the network state, users and participating nodes can be divided into shards, allowing each shard to operate independently. Cross-shard operations are performed by a messaging scheme, a transaction is first executed on the sender shard, and as a result one or more messages along with an execution proof may be sent to other shards to continue the execution. This technique can be advantageous for some applications, e.g., when the logic can be easily partitioned to input and output stages. While such sharding schemes address the network scale, they are not transparent to a various applications and can require special handling of atomic cross-shards operations.

Various blockchain protocols introduce execution-ordering-validation paradigms where execution can be simulated based on the current state, then transactions are ordered and subsequently validated to ensure the execution is consistent with the current state. Techniques for increasing the network transaction rate, by performing optimistic concurrency control by the leader node and sending scheduling hints to the validation nodes have also been implemented. Additionally, techniques for separating ordering from execution have also been implemented for general byzantine fault tolerant services to reduce replica costs and enhance privacy.

Described herein are technologies and related techniques that can be implemented with respect to practically any blockchain protocol that achieves consensus on the ordering of transactions followed by a consensus on their execution. As described herein, the described technologies can, for example, modify the way transaction execution is performed. In doing so, the described technologies can accelerate transaction execution, e.g., through implementation of a strong computational node or entity (which may be referred to herein as an ‘accelerator’ such as accelerator 130 as depicted in FIGS. 1A-1B and described herein). Such an accelerator can perform the referenced execution and can further provide ‘hints’ to various executers/execution node(s). Using the referenced ‘hints,’ the executers can execute and verify parts/portions of the transactions such that the joint parts/portions amount to the valid execution of the block. In doing so, acceleration of the transaction execution can be achieved since the accelerator (having enhancing computation capabilities) executes the entire block relatively efficiently, and each executor may then only need to perform part of the block execution, with the performance of these parts being executed in parallel.

Additionally, the described accelerated protocol can provide additional advantages and benefits. For example, the described technologies can be configured such that the described accelerated protocol does not compromise the security of the system. By way of illustration, in certain implementations the described technologies can be configured such that an accelerator cannot exploit its position to tamper with the execution output or to slow down the process. If an accelerator is not available or ‘misbehaves,’ such activity can be detected and the system can fall-back to a base protocol where execution is done independently by the nodes (e.g., without the involvement of the accelerator).

As the execution is performed on the transactions that were already ordered in consensus, in certain implementations the accelerator is also unable to tamper with the mixture or ordering of the transactions. Likewise, the described accelerated protocol can be resistant to faulty executers. This is achieved through organizing executers in committees, as described herein, thereby making impractical the scenario that a large portion of one of the committees misbehaves.

As noted, in certain implementations the described technologies can be configured to implement multiple accelerators. In certain implementations, such arrangements can be further configured such that, at a given time at most one of the accelerators is operational. Upon identifying misbehavior of the accelerator, the described technologies can be configured to replace the operating accelerator with another. For the sake of simplicity and clarity, certain examples provided in the present disclosure refer to the existence of a single accelerator (such that whenever the accelerator is faulty the base protocol is employed).

Among the advantages of the described accelerated protocol is that when the accelerator is ‘honest’ and the number of executors in the network is moderate, the total running time of the execution is close to that of an efficient execution in a centralized distributed system. Moreover, when the accelerator is faulty, the protocol still enjoys the liveness and security of the execution process of a decentralized system. Another advantage is that unlike many sharding architectures, the parallel execution is performed seamlessly with respect to the application.

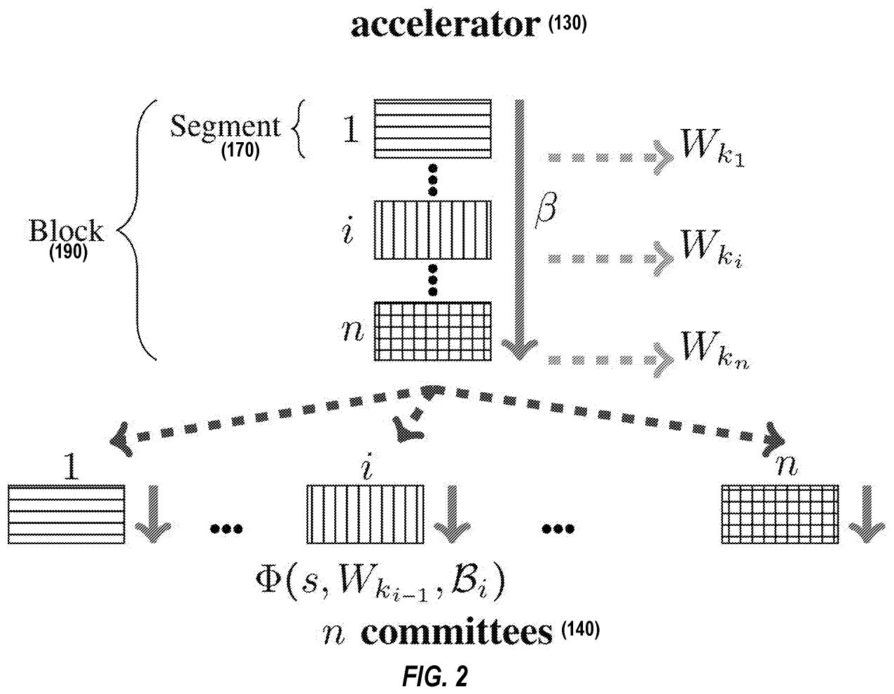

FIG. 2 illustrates aspects of the described accelerated transaction execution. As shown in FIG. 2, the transaction execution of a block 190 can be divided or broken, e.g., into disjointed segments 170 of transactions, e.g., consecutive/sequential transactions. Accelerator 130 can perform execution of the entire block 190. While doing so, the accelerator can save (e.g., for each segment i∈[1, n]) the ‘write’ operations that are the result of execution of the first i segments. Other nodes in the network (e.g., execution nodes 142) can serve as executors and can be organized in committees or shards (e.g., execution shard 140A as shown in FIG. 1A). For example, as shown in FIG. 2, committee i can be configured to verify the execution of segment i, e.g., using the write operations of the first i−1 segments as input for execution. If the transaction execution by the accelerator was not performed correctly then at least one segment was not executed correctly or there is a pair of adjacent segments that are not compatible. In such cases, at least one committee would detect this error and notify the other network nodes. The protocol can then fall to the base execution protocol where execution is performed independently by the executors (e.g., until the faulty accelerator is replaced).

The described technologies and protocols can incorporate various techniques to overcome challenges for achieving correctness, liveness, communication efficiency and minimal storage required from the executors. For example, in order to achieve correctness, the executors can ensure compatibility between the execution of different segments. By way of illustration, the executor can send a shared message to the various committees with information that guarantees compatibility when agreed to by the other committees. The protocol can also account for Byzantine behavior, since both the accelerator and a certain fraction of the executors may be ‘sleepy’ or dishonest. Moreover, to achieve communication efficiency, the described technologies/protocols can incorporate a mechanism for concisely reporting the state from the accelerator to the committees (since sending the entire state may require a large or impractical amount of bandwidth).

In certain implementations, the partition of the transactions can be validated by the accelerator into segments. It may be advantageous to ensure that transactions are not be edited and that their order is maintained. This can be challenging in a scenario in which committees receive transactions of a particular segment (and not all transactions). Accordingly, techniques described herein enable the accelerator to prove the partition validity, e.g., through its approval by the committees.

As noted, FIG. 2 depicts an example illustration of a block transaction execution. The accelerator performs execution β times faster than a (regular) executor. The accelerator provides committee i∈[1, n] ‘hints’ (like Wₖ_{_{i−1}}) which may be needed or useful in executing the i^{th} segment Bⱼ and/or for checking consistency between segments. Doing so enables parallel execution of the different segments by the committees and checking that the block was executed correctly by the accelerator. Each committee can be composed of several executors, each performing this check.

Certain cryptographic data structures are described, referenced, and or otherwise incorporated into the described accelerated transaction execution protocol, including:

Cryptographic Hash Functions—In certain implementations, the hash functions referenced herein can be second preimage resistant. A hash function H can be second preimage resistant if it is hard to find for a given m₁ a preimage m₂≠m₁ such that H(m₁)=H(m₂). L can denote the length in bits of a hash value.

Merkle Tree—A Merkle tree can enable proving a membership of a data element in a set efficiently, without revealing the entire set. Ina Merkle tree, nodes can have Merkle labels, for the leaves this label can be the hash of a data block, and for every non leaf node this label can be the hash of the concatenation of the labels of its children (or the label of its child incase it only has one child). To verify that some data is included in a Merkle tree T, one needs to obtain from a trusted source the label of the Merkle root of the tree, which we denote by MR(T). A Merkle proof for the containment of some data v, which corresponds to a leaf in the tree, consists of the sibling path of the leaf, which contains the labels of all the siblings of the nodes from the leaf to the root. Using these labels, the verifier can compute the label of the Merkle root and check that it is indeed equal to MR(T).

The Merkle trees referenced herein may be second preimage resistant, which means that given a data set it may be impossible to find a different data set such that the Merkle trees of the two sets have a Merkle root with the same label. We note that in order for the Merkle tree to be second primage resistant it must use hash functions that are second preimage resistant, but this is not a sufficient condition, since the Merkle root does not specify the tree depth.

Patricia Tree—A Patricia tree (or a radix tree where the radix equals 2), is a space-optimized trie which enables efficient lookup and updates of data. The Patricia tree differs from a trie when the set of keys is sparse, i.e. the set of keys is a small subset of the entire key space. In this case, branching of the tree one character at a time is inefficient since there are long paths with no branching. Hence the trie is compressed so that every node that is an only child is merged with its parent. We note that when the set of keys is complete in the domain space the structure of the Patricia tree is a complete tree.

For simplicity of presentation, the described technologies are illustrated in relation to key space over binary alphabet, and hence the remitting Patricia tree is a binary tree. Merkle trees referenced herein can mean a Merkle tree where the underlying tree structure is a Patricia tree.

Cuckoo Filter—Along the protocol it may be required to maintain a list of write operations that have to be applied on the state for computing its updated value. We denote by W_{[1 . . . j]} the data structure, holding the write operations for tx₁, . . . txⱼ. A write operation is a mapping from a memory address to its value. Cuckoo filters can be used for holding the operations. In the case of two writes to the same address, only the last written value is kept. This is achieved by locating an element in one of k locations. Upon insertion if all locations are occupied, one location is made available by relocating its content to one of its other k−1 locations. The Cuckoo filter enjoys a fixed time lookup operation with a practically limited insertion time. The number of hash functions k should be a small integer that equals two or can be slightly larger.

Threshold Cryptography—Threshold cryptography includes techniques for allowing joint groups of entities to use a cryptographic system, be it to compute signatures, or to decrypt data In the context of the described technologies, we make use of threshold signatures. In particular, a (t, c)-threshold signature scheme is executed by c entities, any t of which (for some fixed t∈[2, c]) are able to sign a message successfully. Threshold security guarantees that whenever a specified hardness assumption holds, any attempt by up to t−1 of the entities to sign the original message is bound to fail. The (t, c)-threshold signature scheme referred to herein can consist of the following components:

1) A distributed key generation scheme executed once to set up a common public key P K, secret keys (S₀, . . . , S_{c-1}) and verification keys (V₀, . . . , V_{c-1}). 2) A signing scheme by an entity which uses the secret key and produces a signature share. 3) A combine signature scheme which receives as input a message and its signature (set oft shares), together with the public key PK and t verification keys corresponding to the shares and outputs a combined signature. The combine signature scheme checks that each signature share is valid and combines the shares to one signature for the group. 4) A signature verification scheme that receives as input a message and the signature of the group, together with the public key P K. It determines whether the signature is a valid signature created by t entities.

Players and Byzantine model—As described herein, we can assume (for the sake of simplicity and/or illustration) that the identities of the accelerator and all executors are known in advance. We assume that the executors are partitioned to n groups called committees or shards which may be static. For simplicity of presentation we assume each committee has c members. Each participant is aware of the identities of executors in its committee and is aware of identifiable data regarding to other committees (such as the number of committees and the public key associated with each committee).

We regard nodes that are either sleepy or dishonest as faulty. We assume that there are at most a fraction of faulty executors in each committee (where α·c is an integer), and α<¹₂ is a known system parameter. When assembling the committees there is need to make sure that this assumption is justified by taking large enough committees based on α.

For simplicity, we assume that every executor that is nonfaulty (i.e., is alive and holiest) has the same computational power. Denote by β>0 the acceleration parameter, which means that the accelerator performs computations β times faster than the executors.

Messages are either destined to a committee or to all executors. We assume nodes propagate every message they have not received before to all other nodes the message is destined to. Throughout the present disclosure, we assume (for the sake of simplicity/illustration) a strong synchronous network. This means that there is a known fixed bound δ, such that every message delays at most δ time when sent from one point in the network to another. We note that our work can also be adopted to weaker synchrony assumptions.

Ordering Service—The described technologies can follow a paradigm separating transactions ordering from their execution and focus on the execution part. We further assume (for the sake of simplicity/illustration) the availability of an external transaction ordering service (e.g., ordering shard(s) 120 as shown in FIGS. 1A-1B and described herein). The ordering service is responsible for ordering transactions (originating from client device(s) 110) in blocks and reaching consensus on the ordering of these blocks. Each new block can contain a hash pointer to the previous block. Transactions in a block are organized in a Merkle tree, such that each transaction corresponds to a leaf. The hash of the transaction's data is the leaf's label, and the index of the transaction in the block is the leaf's key. The Merkle root of the tree is contained in the block header. We assume that every transaction block received from the ordering service is final in the sense that once a new block of some height is received it will never be replaced by a different block. In our setting the ordering service may not be responsible for performing validations that require executing the transaction and is not responsible for computing the final state of the current block. Accordingly, a transaction block received from the ordering service does not include the new state computed after executing the transactions in the block.

While acceleration of the execution by parallel computation is complex due to the sequential nature of the execution and dependency of a transaction input state by the previous transaction output state, parallel ordering is relatively simpler and can be achieved for example by techniques such as hierarchical consensus.

State transition—‘State,’ as used herein, can refer to data structure(s) containing memory locations and/or the values stored in these locations. For example, the state can be a map composed of a collection of (memory_location, value) pairs. The state enables read operations (lookup by memory location) and write operations (write to memory location). ‘Transaction(s),’ as used herein, can refer to commands that include computations and changes to be performed to the state (e.g., simple or complex computations). State transition can be a deterministic process in which ordered transactions of a block are executed sequentially, receipts and write operations or other such outputs are created and applied to the current state. In certain implementations, write operations are only applied after execution of all the transactions in the block because only then agreement on execution is achieved between network participants and the state can be updated safely. This is the reason we divide the definition of state transition to two processes, execution and applying write operations, as described in further detail herein.

Transaction execution: Aggregated write operations for transaction tx₁, . . . , txⱼ are maintained with the format of (memory location, value) in a data structure denoted by Wⱼ. An example for such data structure can be Cuckoo filter allowing read operation within a constant tine and efficient writes. ‘Transaction execution’ as used herein can refer to a process in which the validity of each transaction is checked, computations are carried out, and the write operations to the state that should be performed as a result are determined (write operations can be for example updating balances or other computation outputs). Execution also outputs a receipt for each transaction, which contains the outcome of the transaction's execution. The input to the execution function φ is a tuple (s, Wⱼ, txⱼ₊₁), where s is the state, Wⱼ is the aggregated write operations up to the j^{th} transaction tx₁, . . . txⱼ that have already been executed but have not been applied to the state yet and txⱼ₊₁ is the transaction to be executed. Executing txⱼ₊₁ may include complex computations and reading and writing multiple values from the memory. The state s and the aggregated write operations together serve as the input memory for execution. When txⱼ₊₁ requires reading some memory location m, a value form is searched in Wⱼ. If it is not found there, then a value for m is searched in s. When the execution of txⱼ₊₁ requires writing some value v to memory location m′ then a tuple (m′, v) is added to the write operations. The output of transaction execution is a tuple (Wⱼ₊₁, rⱼ₊₁), where Wⱼ₊₁ is the updated aggregated write operations, and rⱼ₊₁ is the receipt for the transaction's execution, which contains information about the outcome of executing txⱼ₊₁ (such as outputs, failure notices, etc.). The receipts are not used in the state transition process, their purpose is to update users on the outcome of executing their transactions.

We denote by Φ the execution function for a transaction list (not necessarily a block), B=(txⱼ₊₁, tx_{j+b}). The input to Φ is a tuple (s, Wⱼ, B), where s and Wⱼ are the state and aggregated write operations as before. The output is a tuple (W_{j+b}, R^{B}) which contains the aggregated write operations and the receipts of all the transactions in B. The execution function Φ executes each transaction sequentially using as input the aggregated write operations of all previous transactions in B. That is, the function Φ(s, Wⱼ, B) performs for i=1, . . . , b: (Wⱼ₊ᵢ, rⱼ₊ᵢ)=φ(s, Wⱼ₊ᵢ₋₁, txⱼ₊ᵢ). The function outputs the aggregated write operations W_{j+b} and the receipts R^{B}=(r₁, . . . , r_{b}).

Bound on execution time—Since lookup in the state and the aggregated write operations and writing to the aggregated write operations takes constant time, we get that the time complexity of performing transaction execution may only depend on the complexity of the transaction. We bound the time complexity of executing a single transaction by an executor by a fixed bound T_{φ}^{E}, and if execution exceeds this bound then execution of this transaction halts, no write operations are created for it, and the receipt contains an indication that execution failed. (This means that adding to the aggregated write operations can only be performed after we finish executing the transaction and see that it is valid, and hence the description above does not suffice per se, but for simplicity of presentation we leave it as is.)

Applying write operations: In certain implementations, applying write operations should only be performed after they are finalized, since we wish to avoid rolling back the state to undo operations. After executing the transactions, the apply write function is used to update the current state. That is, the apply write function Ψ receives an initial state s and aggregated write operations W and updates the state s←Ψ(s, W) by adding all the memory location, value pairs in W to the state.

Execution Service—The execution service is responsible for performing state transition fora transaction block B=(tx₁, . . . , tx_{b}) received from the ordering service, and for reaching an agreement on the state transition outputs. The output of state transition is an updated state s, block receipts R^{B} and aggregated block write operations W^{B}. The state is stored in a Merkle tree, indexed by memory location, which is updated with every block executed. The receipts are stored in a Merkle tree, created for each block of transactions, indexed according to the transaction's number in the block. In certain implementations, the block receipts tree R^{B} is never updated after its creation. The aggregated writes data structure keeps tuples of memory location and values allowing efficient read and write operations.

In certain implementations, for every block B received from the ordering service, after performing execution an execution digest is created. The execution digest contains the Merkle root of the state before performing state transition of B, the Merkle root of the receipts tree R^{B} and the hash of the aggregated block write operations W^{B}. In more detail, the execution digest of a block B of height [symbol] includes:

The height number [symbol] .
A hash pointer of the ( [symbol] −1)^{th} execution digest.
A hash pointer of the [symbol] ^{th} ordering block B header.
The Merkle root of the state tree after the execution of block [symbol] −1.
The Merkle root of the block receipts tree R^{B}.
The hash of the aggregated block write operations, W^{B}.

For each executed block B, the execution service reaches consensus on the outputs s, W^{B} and R^{B}, and a certificate for the execution digest is created in the process.

The base execution protocol can be used in the absence of an accelerator or after identifying a problem when running the accelerated execution protocol. The base protocol performs transaction execution for a transaction block and reaches agreement by creating a certificate for the execution digest within its committee. Reaching agreement on transaction execution (as opposed to having each executor perform it separately) enables fast synchronization on the outcome of transaction execution. That is, if an executor was asleep and wakes up and wished to synchronize on the state and execution outputs, it does not have to perform the execution of all the blocks by itself and instead can rely on the execution digest, as described herein. Other reasons for reaching agreement on execution is to have a reliable record, and for consistency with the accelerated protocol. The protocol is run by each executor in each committee independently. The protocol proceeds in terms, where in each term a single block is executed and certificate for its execution is generated.

Initial protocol setup—Each executor can generate signature keys and distributes its public keys to the other committee members.

Term Description:

Term initialization—Once the previous term has ended and the block B that succeeds the last block that has a certified execution digest is available (i.e., it has been received from the ordering service), the executor initiates the term.

1. Executing the block. The executor executes the new block B. That is, it computes (W^{B}, R^{B})=Φ(s, ø, B) where W^{B} is the aggregated block write operations and R^{B} is the block receipts.

2. Signing execution digest. The executor creates an execution digest D^{B} containing: the Merkle root of the receipts tree R^{B}, a hash of the block write operations W^{B} and the Mettle root of the state s. The executor then signs the digest using its public key. It sends the digest to its committee members. Note that s can be the state of the previous term (since write operations have not been applied to the state yet). We include the state Merkle root in the digest for the record and for allowing nodes to synchronize on the state without needing to start from the execution of the genesis block.

3. Constructing a certificate Cer(D^{B}) for the digest—The executor collects signatures for the execution digests from its committee members. A digest message for the term that received signatures from more than a fraction of the committee members is considered certified. (If the executor obtains a certified digest before it finished executing the block, it can perform fast synchronization as explained below and then proceed to applying write operations, even though it did not perform steps 1 and 2.)

4. Applying write operations—The executor applies the write operations s←Ψ(s, W^{B}) in order to compute a new state s and proceeds to the next term.

Reaching an agreement on execution and obtaining a certificate does not include interaction between committees. Indeed, this may not be necessary since the protocol outputs, s, W^{B} and R^{B}, are the same for every committee that executes the protocol. The proof for this is provided herein. In certain implementations, communication between committees in the base protocol is performed only in order to decide when to initiate or return to the accelerated execution protocol, according to a predetermined policy which is out of scope of this work.

In certain implementations, the reason that write operations are applied to the state only after a certificate is obtained is in order to be consistent with the accelerated protocol, there it is important that the state is not updated before consensus is reached.

Fast Synchronization—It is possible that an executor obtains certified digests before it finished executing the relevant blocks. This means that other network nodes are already in a later term, and the network node needs to catch up with them in order to participate in the protocol. For example, this can happen if the executor crashed, and then wakes up. Fast synchronization enables an executor to perform state transition quickly, without performing execution. This is performed by obtaining a copy of R^{B}, W^{B} and Cert(D^{B}) of the block B following the last block it executed. First it checks that Cert(D^{B}) is a valid certificate that contains signatures of more than an a fraction of its committee members. It then computes the Merkle root of R^{B} and the hash of W^{B} and checks that the values are as in the certified digest Cert(D^{B}). If they are not, it requests other executors to send R^{B} and W^{B} until the check passes. The executor can then update its state safely by applying the write operations in W⁵ to its current state. It can continue doing this for every block sequentially until reaching the last block that has a certified digest.

The Accelerated transaction execution protocol is an interactive protocol between accelerator(s) A, and n committees of executors each in charge of executing a segment and verifying that the execution process was performed correctly by the accelerator. The present disclosure provides both an overview of the protocol, and a detailed description.

Accelerator 130 can be a computationally strong entity node, device, service, etc. that performs transaction execution β times faster than other nodes, and its responsibility is both performing the entire execution as well as breaking or dividing the execution into segments 170 for the executors. The accelerator is given as input an ordered block or set B of transactions (190). As described herein, the accelerator divides or partitions the transactions into n (disjoint) consecutive segments B¹, B², . . . , Bⁿ and computes a partition proof p that the segments are indeed a legal partition of B. The accelerator executes the segments sequentially computing the write operations and receipts of each segment.

The accelerator sends the executors in committee i (e.g., nodes 142A, etc., within execution shard 140A, as shown in FIG. 1A) the i^{th} block segment Bⁱ and the receipts and write operations of all segments. With this information, each executor in committee i executes the i^{th} segment (using the write operations of the first i−1 segments as inputs for execution) in order to compute the write operations and the receipts for the i^{th} segment and checks that they are equal to the ones it received from the accelerator. In addition, the accelerator sends all the committees the execution digest D which contains a proof that the block was validly partitioned, and the required Merkle roots and hash values. The executor checks that the block execution outputs it receives are compatible with the values in the digest.

The executers communicate within their committee, and then across committees and output their verdict regarding to the segment partition and execution. If the process was performed correctly, they create a certificate for the execution digest, and update the state by applying the block write operations. Otherwise, if there is a problem with the partition or the execution, the executors fail the accelerated protocol and fall back to the base protocol until replacing the accelerator (e.g., the ordering shards 120 provide transactions directly to execution shards 140, as shown in FIG. 1A).

In certain implementations, the referenced committee(s)/execution shards 140 can be configured to check the execution of one segment (e.g., segment 170A), and check that this segment is compatible with the entire block's (190) execution. In the absence of Byzantine nodes, a single executor can perform the described role/operations of the entire committee/shard. However, since some of the executors may be faulty, it may be advantageous to utilize multiple executors/nodes 142A, 142B, etc. in a committee/shard in order to ensure that at most an a fraction (where a is a constant smaller than ¹₂) of the executors in each committee are faulty. We denote by c the number of executers in a committee and let s be the initial state prior to the execution of the block.

Further aspects of the described technologies/protocol are provided below.

The Accelerated Transaction Execution Protocol—The protocol can initialize its setup once and then operates in terms such that in each term a single block is executed. We note that at a given time it is possible that the accelerator has already progressed to alater term than the executors. It is also possible that the executors are not on the same term.

Initial protocol setup—For i=1, . . . , n the executors in committee i run a distributed key generation protocol of a (a·c+1, c)-threshold signature scheme. The committee public key P Kᵢ is sent to all executors in the other committees. The accelerator 130 generates a secret key for the signature scheme and sends its public key to the executors. (Upon receiving a message in the protocol, the receiver checks that the message was indeed sent by the claimed entity by checking its signature.)

The protocol proceeds in terms, where in each term the consecutive block to the one from the previous term is processed. A term is divided to the accelerator's part and the executors' part.

Term Description the Accelerator's Part:

Initialization of accelerator's term. Once the previous term has ended and a block B (190) that succeeds the block from the previous term is available (i.e., it has been received from the ordering service), the accelerator initiates its term.

Partitioning and sending block segments—Given the set of transactions in a block B=(tx₁, . . . , tx_{b}) and the number of committees n, the accelerator 130 runs a process for partitioning the transactions in the block into n (disjoint) consecutive block segments B¹, . . . , Bⁿ (e.g., segments 170A, 170B, etc., as shown in FIG. 1A) such that for i∈[1, n] the transactions in the i^{th} segment are Bⁱ=(txₖ_{_{i−}}₊₁, . . . , txₖ) where k₀=0≤k₁≤ . . . ≤kₙ=b are the indices the block is partitioned at. Namely, the set of transactions and their order should not be modified relative to the original block. The block is partitioned into segments such that computing state transition of each segment takes a similar time, up to some factor γ>1 (This can be done by relying on the time observed by the accelerator during execution). In particular, the time it takes an executor in the i^{th} committee to compute state transition for the i^{th} segment should be at most γ·ₐ^{b}·T_{φ}^{E}, using the bound defined in IV-C.

The accelerator 130 sends committee i (e.g., execution shard 140) the transaction segment B^{l} and also creates a partition proof μ which serves as a proof that the block was partitioned as required. Further aspects of the proof μ and its verification are provided herein.

Performing execution and sending execution outputs—The accelerator performs transaction execution of the segments B¹, . . . , Bⁿ in sequential order. That is, for i∈[1, n] it computes (Wₖ, rₖ_{_{i−}}₊₁, . . . rₖ_{ᵢ}₎₎₌Φ(s, Wₖ_{_{i−1}}, Bⁱ). It then sends each executor the block receipts R^{B}=(r₁, . . . , r_{b}), the block write operations W^{B}=W_{b} and the write operations at the end of the (i−1)^{th} segment Wₖ_{_{i−1}}.

Creating execution digest D^{B}—After finishing the execution of the block, the accelerator sends all committees a digest that contains one or more of the following:
The term number.
The partition proof μ (see below). The partition proof contains the indices the block segments are partitioned at.
The hash values of the write operations at the end of each segment's execution: H(Wₖ_{ᵢ}), H(Wₖ_{₁}), . . . H(W_{b})=H(W^{B}).
The Merkle root of the block receipts tree, denoted by MR(R^{B}). The block receipt tree R^{B} is the Merkle tree of the block receipts indexed by transaction number in the block.
The Merkle root of the states (prior to the block execution).

Applying write operations to state—The accelerator applies the write operations and updates the state s←Ψ(w, W^{B}), this ends the term.

Term Description the Executor's Part:

In certain implementations, the following process is performed within each committee i∈[1, n], by each executor in the committee.

Initialization of executor's term—Once the previous term has ended and the header for the block B that succeeds the previous verified block is available (i.e., it has been received from the ordering service) then the executor/execution node initiates the term and resets the term's clock.

Segment execution and validations—An executor in the i^{th} committee can perform the following checks:
(i) Checking the state Merkle root in the execution digest: The executor checks that the value of the root of the state in the execution digest is equal to the Merkle root of the state that it holds which was updated in the previous term
(ii) Validating the partition proof μ: After receiving the partition proof μ and the block segment B′ the executor checks that B′ is indeed a valid i^{th} block segment of B using μ and the transaction Mende root in the header of B. Further details can be found herein.

(iii) Checking consistency between Wₖ_{ₖ}ᵢ₋₁, W^{B}, R^{B} and the execution digest: The executor computes the hashes of Wₖ_{_{i−1}}, W^{B} and the value of the Merkle root of R^{B} and checks that they are equal to the values in the execution digest.
(iv) Executing the block segment: The executor executes the i^{th} segment by computing: (Wₖ_{₁}, (rₖ_{_{i−j}}₊₁, . . . , rₖ)=Φ(s, Wₖ_{_{i−1}}, B′) and checks that the hash of Wₖ is equal to the value in the execution digest, and that the receipts (rₖ_{_{i−1}}₊₁, . . . , rₖ_{ᵢ}) are equal to the receipts of transactions kᵢ₊₁+1, . . . kᵢ in R^{B}.

If one of the checks fails then the executor signs a fail message (Fail, term_num) for the term and sends it to the other executors in its committee (see below). Otherwise, if all checks pass, then the executor signs the execution digest and forwards its signature to the other executors in the committee.

Reaching a verdict on a segment within a committee—Within each committee i∈[1, n], the executors collect signature shares for the execution digest. When α·c+1 of the signatures are collected for an execution digest D^{B}, then the executor combines the shares to generate a single signature Sigᵢ(D^{B}) of the committee (using the threshold signature scheme) and forwards this combined signature to the other committees.

Reaching a verdict on the block execution—The executor collects the signatures for execution digests D^{B} from all committees 1, . . . , n.

Collecting failure signatures—Throughout the term, the executor collects failure messages from the executors in its committee, and if α·c+1 signatures are received for failing some term [symbol] (which might not be the term it is in right now) the executor combines them to generate a committee failure message and forwards this message to the other committees. When the executor receives a committee failure message for some term [symbol] (from some committee) then it falls to base execution protocol, starting execution from the block being executed in its current term.

Obtaining block receipts and block write operations if needed—In case the executor does not hold the block receipts R^{B} and write operations W^{B} that are consistent with the certified digest, then it needs to request them from the other executors. This can happen if the executor was not live, or if the accelerator was faulty, and for some message in the protocol, sent multiple versions of the same message. In this case the executor only keeps the first copy of the message it received, which may not be the version containing the execution outputs of the certified digest. After receiving block receipts and write operations from a committee member, the executor checks consistency between R^{B}, W^{B} and the certified execution digest as explained herein.

We assume obtaining block receipts and write operations takes at most δ_{wait} time, and in any case (even if the executor already obtained the receipts) it waits this long before applying write operations.

Applying block write operations—The executor updates the state using the block write operations: s←Ψ(s, W^{B}), this ends the term.

For running time analysis, we differentiate between computations that can be performed in parallel to a large extent (e.g., at a single computer) and the sequential computation of transaction execution. Computations that can be performed in parallel include: computing hash value of W^{B}, computing the Merkle root of R^{B} ands (the hashes of all nodes in one layer of the tree can be computed in parallel, and hence the time complexity of the computation is O(log h) where his the height of the tree), verifying signatures and signing messages.

We use the following upper bounds which can be known system parameters:
The time for executing one transaction by the executors is at most T_{φ}^{E} for some large constant. (Note that execution time does not depend on the sizes of the state or the aggregated writes since it takes O(1) time to read from them. Hence the time only depends on the complexity of the transaction and the computation power of the executor E.)
The number of transactions in a block is at most bₘₐₓ.
The number of memory locations (i.e., data values) in the state is at most sₘₐₓ.
Each transaction updates at most mₘₐₓ memory locations, where mₘₐₓ is a relatively small constant.

Upper bounds on running time base execution protocol—Executing the block. We assumed that the execution time of a transaction by the executors is at most T_{φ}^{E} and there are at most bₘₐₓ transactions in a block. Hence execution of a block takes at most T_{φ}^{E}·bₘₐₓ time. Computation time of the hash of W^{B} and the Merkle root value of R^{B} can be performed in parallel and hence in O(log bₘₐₓ) time which we denote as δ_{H}.

Signing execution digest. We denote this time by δ_{sig}. Constructing a certificate Cer(D^{B}) for the digest. This simply requires receiving the signature, which takes δ time, and verifying, which can be performed in parallel. We denote the time it takes by δᵥ.

Applying write operations. Using our assumption on the number of transactions in a block and the number of write operations for each transaction, we get that the number of write operations in W^{B} is at most bₘₐₓ·mₘₐₓ. Updating write operations can be optimized to run in parallel, and hence takes O(log(sₘₐₓ)), which we denote by δₛ.

In total: We get that a term of the base execution protocol terminates in T^{B}:=T_{φ}^{E}·bₘₐₓ+δ_{H}+δᵥ+δ+δₛ time.

Upper Bounds on Running Time Accelerated Execution Protocol

Accelerator's part: The total bound on the accelerator's part is

$${T}^{AP} := \text{?} \cdot {b}_{ma x} \cdot {T}_{φ}^{E} + {δ}_{H}^{A} + {δ}_{s}^{A} , \\ \text{?} \text{indicates text missing or illegible when filed}$$

where the parameters and more details are given below:

Partitioning into block segments—The partition follows the block execution. The partition proof μ includes the Merkle roots for subtrees in the Merkle transaction tree. The roots are computed as part of the calculation of the root of the whole tree (and thus may not require further computations).

Performing execution and sending execution outputs—We assumed that the execution time of a transaction by the executors is at most T_{φ}^{E}. Hence the execution time of the accelerator is at most

$$\text{?} \cdot {b}_{ma x} \cdot {T}_{φ}^{E} , \\ \text{?} \text{indicates text missing or illegible when filed}$$

where β>1 is the accelerator's computational speedup and bₘₐₓ is the maximal number of transactions in a block. Computing the hashes of the aggregated writes can be performed in parallel and we denote the time it takes by δH^{A}.

Creating execution digest. Does not require any extra computations so we can neglect its time.

Applying write operations to state—As explained with respect to the base execution protocol, this takes the executors hence takes O(log(sₘₐₓ)), which we denote by δₛ^{A}.

Executor's part: The time bound on the executor's part

$${T}^{EP} := {δ}_{μ} + y \cdot \text{?} \cdot {T}_{E φ} + 2 {δ}_{H} + 2 {δ}_{v} + 2 δ + {δ}_{wait} + {δ}_{s}$$

$$\text{?} \text{indicates text missing or illegible when filed}$$

where the parameters and more details are given below:

Segment execution and validations.

(i) Checking the state Merkle root: Does not take additional computation time since it has already been computed.

(ii) Validating partition proof: An executor verifies values in the Merkle transaction tree. This can require computing the roots for subtrees in the assigned segment in O(bₘₐₓ) time as well as the root of the whole Merkle tree based on the values in the proof in O(n·log bₘₐₓ), which we denote by δ_{μ}.

(iii) Checking consistency between Wₖ_{_{i−1}}. W^{B}, R^{B} and the execution digest: The sizes of Wₖ_{_{i−1}}, W^{B} and R^{B} are O(bₘₐₓ). Computation time of the hash of W^{B} and the Merkle root value of R^{B} can be performed in parallel and hence in O(log bₘₐₓ) time which we denote by δ_{H}.

(iv) Executing the i^{th} block segment: We assumed that the execution time of a transaction by the executors is at most T_{φ}^{E}. The segments are partitioned so that execution of a segment by the executors takes at most

$$γ \cdot \text{?} \cdot {T}_{E φ}$$

$$\text{?} \text{indicates text missing or illegible when filed}$$

time where γ≥1 and γ=1 for an ideal partition. Computation time of the hash and checking that receipt values are the same takes an additional δ_{H} time.

Reaching a verdict on a segment within a committee—in certain implementations, this can require receiving the signature, which takes at most δ time, and verifying, which can be performed in parallel, we denote the time it takes by δᵥ.

Reaching a verdict on the block execution—E.g., as within a committee, δᵥ+δ time total.

Timeout—Summing the accelerator's running time and the executor's running time up to this point yields the timeout:

$${T}_{timeout} := ( \text{?} + \text{?} ) \cdot {b}_{ma x} \cdot {T}_{φ}^{E} + {δ}_{H}^{A} + {δ}_{s}^{A} + {δ}_{μ} + 2 {δ}_{H} + 2 {δ}_{v} + 3 δ$$

$$\text{?} \text{indicates text missing or illegible when filed}$$

Obtaining block receipts and waiting for others to—This is δ_{wait} time.

Applying block write operations—As explained in the accelerator's part, this takes O(log(sₘₐₓ)), which we denote by δₛ.

Also described herein are aspects that further illustrate advantages and features of the described technologies, including demonstrating that the protocol satisfies fundamental desired properties such as liveness and safety. We also analyze its running time and consumed bandwidth.

Theorem 1: (liveness) For every term, every non faulty executor obtains the outputs of state transition and a certificate for them by some time T, regardless of whether the accelerator is faulty. Moreover, when the accelerator is non-faulty, the outputs of state transition and the certificate are obtained using the accelerated execution protocol by time T^{AP}+T^{EP}+δ (defined in the running time analysis).

Proof: We demonstrate liveness under two scenarios referring to the status of the accelerator:

(i) The accelerator is non-faulty. Fix some term number [symbol] and assume the accelerator was non faulty up to this. We show that every non-faulty executor obtains the output of state transition and a certificate for them by time T^{AP}+T^{EP}+δ. Fix a non faulty executor e. When the accelerator is nonfaulty, then the accelerator competes its part in time T^{AP} (as described herein in relation to running time analysis). The executor can initiate its term at most δ time before the accelerator (since the block header reached all network nodes within δ time of each other and the accelerator necessarily finished its part in the previous term before the executors.) It follows that the accelerator's messages were received by every non-faulty executor by time T^{AP}+δ (according to e's clock).

Every non-faulty executor performs segment execution and validations by time T^{AP}+δ+ₙ^{γ·b}_{max·T}_{_{φ}}^{E}+δ_{μ}++2δ_{H} according to e's clock, as explained in the running time analysis. (Here we also use the fact that all non-faulty executors initialize their term within 6 time of each other, and we show herein that this property is maintained for the next term). Note that since we assume that the accelerator is nonfaulty, it follows easily that each of the validations pass, state execution outputs W^{B}, R^{B} are received and a signature is produced for digest D by every non-faulty executor. There are (1−α)·c non-fault executors in each committee, and e collects all their signatures. Since

$$a < \text{?} , \\ \text{?} \text{indicates text missing or illegible when filed}$$

we get that e collects at least α·c+1 signatures from its committee members by time

$${T}^{AP} + \text{?} \cdot {b}_{ma x} \cdot {T}_{φ}^{E} + {δ}_{φ} + 2 {δ}_{H} + {δ}_{v} + 2 δ$$

$$\text{?} \text{indicates text missing or illegible when filed}$$

according to e's clock Finally, e receives all the committee signatures by time

$${T}^{AP} + \text{?} \cdot {b}_{ma x} \cdot {T}_{φ}^{E} + {δ}_{μ} + 2 {δ}_{H} + 2 {δ}_{v} + 3 δ$$

$$\text{?} \text{indicates text missing or illegible when filed}$$

which serve as the certificate for the outputs of state transition.

To end the term, the executor waits T_{wait} time for executors to obtain execution outputs if needed, and then applies the block write operations to its state in order to obtain an updated state, which ends the term. This is done it total by time T^{AP}+δ+T^{EP} according to e's clock. Moreover, since all non-faulty executors receive the certificate within δ time of each other, and applying write operations takes the same time, executors initialize the next term within δ time of each other.

(ii) General liveness proof—We divide the general liveness proof (where the accelerator may be faulty) to two parts, when executors are in the accelerated execution protocol and when they are in the base protocol.

Executors are running the accelerated execution protocol—We show that, in certain implementations, within Tₜᵢₘₑₒᵤₜ+δ either all non-faulty nodes receive a certified digest and can then obtain the execution outputs by time Tₜᵢₘₑₒᵤₜ+δ+T_{wait}, or they all fall to the base execution protocol within δ time of each other, and we show liveness for this case in herein.

When the accelerator may be faulty there may be two options. Either the executor obtains before time Tₜᵢₘₑₒᵤₜ a certificate for a digest D. In this case if the certificate it obtained was not for the digest that it signed then it obtains block receipts and write operations using the procedure described in the protocol, and then initializes the next term (either way executors can initialize their term within δ time front each other). Otherwise if the executor does not obtain before time Tₜᵢₘₑₒᵤₜ a certified digest, then if it did not do so already it signs a fail message for the term. Since all other non-faulty executors that did not receive a certificate do the same, and since term clocks are the same up to δ factor, then within time Tₜᵢₘₑₒᵤₜ+δ it either receives a failure message from at least α·c+1 executors in its committee (as described herein regarding receiving a committee failure message), or otherwise there exists at least one nonfaulty executor that did not sign a failure message at time Tₜᵢₘₑₒᵤₜ. This means that this non-faulty executor received a certified digest, and hence all non-faulty nodes will obtain one by time Tₜᵢₘₑₒᵤₜ+δ.

Receiving a committee failure message may happen either when a certified execution digest is not obtained by time Tₜᵢₘₑₒᵤₜ, as described above (in this case the committee failure message is received by time Tₜᵢₘₑₒᵤₜ+2δ), and it may also happen in other cases, either prior to Tₜᵢₘₑₒᵤₜ if the messages the accelerator sends are not valid, or after Tₜᵢₘₑₒᵤₜ+2δ. Note that if it is received after Tₜᵢₘₑₒᵤₜ+2δ it means that the last executor that signed it was faulty and did not follow the protocol, and in particular a certificate for the term was already received. The result of a late committee failure message is falling to the base execution protocol starting from the last term that has a certified digest. Hence a faulty executor cannot exploit this behavior for taking the protocol to an earlier term and harm liveness.

Once an executor receives a committee failure message, in certain implementations it can be guaranteed that all non-faulty executors will receive one in δ time and they will all fall to the base protocol starting from the latest term that they have a valid certificate for. If needed they obtain the execution outputs W^{B} and R^{B} in time T_{wait} before starting the base execution protocol term.

Liveness in the base execution protocol—If a non-faulty node fell to base protocol, in certain implementations it must be that it received α·c+1 failure signatures for the term, and hence all non-faulty nodes will also receive them and fall to base protocol within S time. Since execution is deterministic, and we have finality on the blocks received, then for each term all non-faulty executors obtain the same execution outputs and sign the sale execution outputs. Using the running time analysis one can readily verify that each term terminates within T^{B}:=T_{φ}^{E}·bₘₐₓ+δ_{H}+δᵥ+δ+δₛ time (see running time analysis as described herein).

Theorem 2: (Correctness) An execution digest of some term that receives a certificate contains a fingerprint of the correct state transition outputs (the hash of W^{B} and Merkle roots of R^{B} and of the state of the previous term), and every non-faulty executor that signed the certificate holds these outputs.

Proof: We prove the claim inductively and assume that up to some term an execution digest that receives a certificate contains a fingerprint of the correct state transition outputs, and we show this also holds for the next term. Denote by D an execution digest that receives a certificate for the term. In each committee α·c+1 executors signed D, so at least one non-faulty executor from each committee signed the digest. We denote these executors by e₁, . . . eₙ. Because e₁ . . . eₙ participate in the term, we know that they finished their previous term, and hence they hold a certificate for the previous term, and from the induction hypothesis they also hold the correct state at the beginning of the term.

In certain implementations, we divide into two cases, if the certificate was obtained using the base execution protocol, or the accelerated protocol (recall that the digest contains a flag if it was obtained with the accelerated protocol). If the certificate was obtained using the base protocol, then it is easy to determine that it contains a fingerprint of the correct state transition outputs, since e₁, . . . eₙ are non-faulty and they performed the entire block execution independently, computed W^{B} and R^{B} and composed the execution digest D by themselves, containing the correct hash and Merkle roots. They then applied W^{B} to the current state to obtain the next one.

The second case is if the certificates was obtained using the accelerated protocol. First note that e₁, . . . , eₙ all received the same aggregated block writes W^{B} and block receipts R^{B} from the accelerator, since otherwise their hash and Merkle root would be different from the ones in D and validation (iii) would fail. We also know that the Merkle root of the state in D is correct, since e₁, . . . , eₙ check in validation (i) that it is equal to the value they hold. It is left to show that W^{B} and R^{B} that they received were computed correctly and the updated state they hold at the end of the execution is correct.

We show that W^{B} and R^{B} are the valid aggregated block writes, and block receipts. For every i∈[1, n] the aggregated writes computed when executing the segment, W_{k,1} is equal to the aggregated writes e, received as input for the execution, because otherwise their hash values would be different, and either validation (iv) of executor eᵢ₊₁ or validation (iii) of executor eᵢ₊₁ would fail. Together with the fact that B¹, . . . Bⁿ is a legal block partition (since validation (ii) passed, see also correctness of partition proof in IX) and that the executors all hold the correct state at the beginning of the execution, we get that for i∈[n] the execution of the entire block is performed correctly according to:

Wₖ₁(kᵢ₊₁_{⁺¹}, . . . rₖ_{ᵢ})=Φ(s,Wₖ_{_{i−1′}}B′) (1)

It follows that the aggregated block writes Wₖ_{ₐ}=W^{B} are computed correctly (i.e. according to the function Φ: (W^{B}, R)=Φ(s, ø, B)). Regarding the block receipts, from validation (iv) we know that for i∈[1, n] the receipts of transactions kᵢ₋₁+1, . . . , k₁ in R^{B} are (rₖ_{_{i−1}}₋₁, . . . , rₖ_{ₙ}) which were validly computed according to. The n^{th} committee, and in particular executor eₙ checks that there are no receipts in R^{B} after kₙ=b. Thus R^{B}=(r₁ . . . , rₖ_{ₙ}) is the valid block receipts.

Because e₁, . . . , eₙ hold the correct state at the beginning of the segment, it follows after applying the write operations W^{B} the new state they hold is the correct state for the end of the term.

Triggering verification—A naive way for verification is to have the accelerator terminate its execution, output auxiliary data π and s_{owi}, and only then start the verification process. However, in order to minimize the running time of the protocol, we can have the i^{th} committee start the execution of the i^{th} segment as soon as the accelerator completed computing Hence, we have the accelerator publish the auxiliary data on the fly as it computes it, and the committee can start executing as soon as πᵢ=sᵢ₋₁, is published by the accelerator. Then after the i^{th} committee terminates with the segment's execution, and πᵢ is published, the committee performs the verification checks mentioned above. This approach allows committees to start their computation in different time. While trying to minimize the latest computation by one of the committees, this encourages uneven partition of the transactions among the committees such that earlier ones should be allocated more transactions.

In the protocol the accelerator partitions an (ordered) block B into n disjoint block segments B₁, . . . Bₙ and sends segment Bᵢ to the i^{th} committee. It can be advantageous to ensure that the partition is valid such that the transactions in B₁, . . . Bₙ are identical to those of B=(tx₁, . . . , tx_{b}) and they appear in the same order, that is, the two sequences of transactions in B and (B₁, B₂, . . . , Bₙ) are identical. In certain implementations, existing transactions should not be modified or omitted and new transactions should not be added.

The accelerator demonstrates that through a partition proof μ that it sends to all n committees. Each committee i∈[1, n] verifies μ with the help of information taken from its segment Bᵢ and signs the proof μ if the test passes. In certain implementations, the design of μ can guarantee that: (i) a valid partition is approved by all nonfaulty executors; (ii) approval by non-faulty executors from all committees implies that a partition is valid. Furthermore, for communication efficiency it can also be advantageous to reduce the length of the proof as possible. An inherent challenge for such verification process is the partial view each committee has based on the transactions it receives while the correctness of the partition is affected from the relation between block segments (such as disjointness and full coverage of the block).

Construction of a partition proof—We describe one example construction of a partition proof μ and explain how it is verified. We refer to the Merkle tree T (B) of the block of transactions B shortly as T. In the Merkle tree, transactions appear as leaves and an internal node's hash value is computed based on the hash values of its direct descendants. Executors receive the Merkle root for T from the ordering service in a secure way, as part of the block header. Consider the set of allocated transactions Bᵢ for a committee i∈[1, n] and the corresponding set of leaves. The block segment Bᵢ contains the transactions' indices in the block, which correspond to the keys of the transactions within the Merkle tree T. Segment Bᵢ can be described as a disjoint union of transaction sets, such that each set corresponds to a subtree of the Merkle tree. (By subtree we refer to a node and its descendants in the tree where each leaf corresponds to a transaction.) We consider such a union where each subtree is of a maximal size, namely no two subtrees for Bᵢ can be merged to a larger subtree. Let Tᵢ={T_{i,1}, T_{i,2}, . . . } be the subtrees for segment Bᵢ assigned to committee i. Likewise, let Pᵢ={p_{i,1}, p_{i,2}, . . . } be the corresponding Merkle roots, namely the hash values for these subtrees. Each root for a subtree is associated with the location of the subtree in the Merkle tree. Let μ={P₁, . . . , Pₙ} be a partition proof, including for each segment the list of roots for its subtrees. We explain how μ can be tested to check whether the partition is valid. The proof can be tested independently by executors of each committee and a positive indication from all committees is required.

Verifying a partition proof—To verify a partition based on its proof, an executor in the ifth committee can perform the following checks:

(i) Validity of Merkle roots for the segment Bᵢ. An executor partitions the transactions of segment B, into subtrees using their indices in the block B (that were received in Bᵢ) which determine their location in T. It then computes the Merkle root for each of the subtrees and compares the roots to those that appear in Pᵢ.

(ii) Validity of the Merkle root for the block B. An executor makes use of the Merkle root sets P₁, . . . , Pₙ along with their locations to compute hash values for larger subtrees composed of transactions from multiple segments. This process can be performed bottom-up starting from the lowest level roots in μ until computing the root of the complete Merkle tree, and comparing it to the value received in the header of block B. An executor does that based on the transactions of its segment and the hash values for the roots for other segments reported in the proof.

Correctness of proof verification—We show the following property of the proof verification:

Theorem 3: The proof verification correctly determines the validity of a partition.

We first explain that a valid partition is approved by all nonfaulty executors and thus by all committees. Within each segment an executor partitions a segment to subtrees as done by the accelerator, following the segment's location in the Merkle tree. It then computes the hash values in each of the subtrees based on the transactions in the segment B. Likewise, computing the Merkle root for the complete block B can be done by the executor based on the hash values of P₁, . . . , Pₙ, without knowledge on the particular transactions in each of these subtrees. If the partition is valid, the root computed by the executor matches the Mende root in the block header.

We also show that when the set of transactions is modified by the accelerator the partition is not approved. We explain that executors of at least one segment identify that and do not approve the partition proof Executers in each committee calculates the Merkle root for the block based on P₁, . . . , Pₙ. If this matches the known Merkle root for the block, this implies that P₁, . . . , Pₙ refer to a legal partition. To finalize the verification the i^{ih} committee also checks that its hash values in Pᵢ matches its assigned segment Bᵢ.

In case of an illegal partition, the sequence of transactions (B₁, B₂ . . . , Bₙ) differs from that of the block B. Let i be the first committee for which its assigned segment Bᵢ implies a change in the sequence. Formally, i=min{j∈[1, n]|(B₁, B₂, . . . , Bⱼ) is not a prefix of B} and let i=n if (B₁, B₂, . . . , Bₙ) is a prefix of B. By the definition of i, and since the Merkle tree is second pre-image resistant, the Merkle roots for the subtrees of Bᵢ differ from those in Pᵢ. Otherwise, the transactions of Bᵢ are the same as in B and also (B₁, B₂, . . . , Bᵢ) is a prefix of B. Accordingly, a non-faulty executor in the i^{th} committee does not approve the block partition and the partition will not be verified. Note that in particular, if i−n then if the hash values for Bᵢ match those in P₁, the fact that the Merkle root for the whole block was computed correctly based on P₁, . . . , Pₙ implies that all transactions in B appear in (B₁, B₂, . . . , Bₙ) and the partition is legal.

Length of a partition proof—We can derive an upper bound on the length of the above partition proof μ. The partition proof μ={P₁, . . . , Pₙ} includes the list of roots for the subtrees of each of then segments. For simplicity we assume that the number of transactions b in a block is a power of two. The height of the Merkle tree T is log₂(b)+1. The list of Merkle roots Pᵢ for segment Bᵢ has a root for each subtree within the segment. For each segment, the number of subtrees is at most 2(log₂(b)−1). Accordingly, μ includes at most 2n·log₂(b) hash values. Note that the location of the subtrees for a segment can be derived by the total size of previous block segments. This brings the length |μ| of the partition proof to be (2n·log₂(b))·L where L is the length in bits of a hash value.

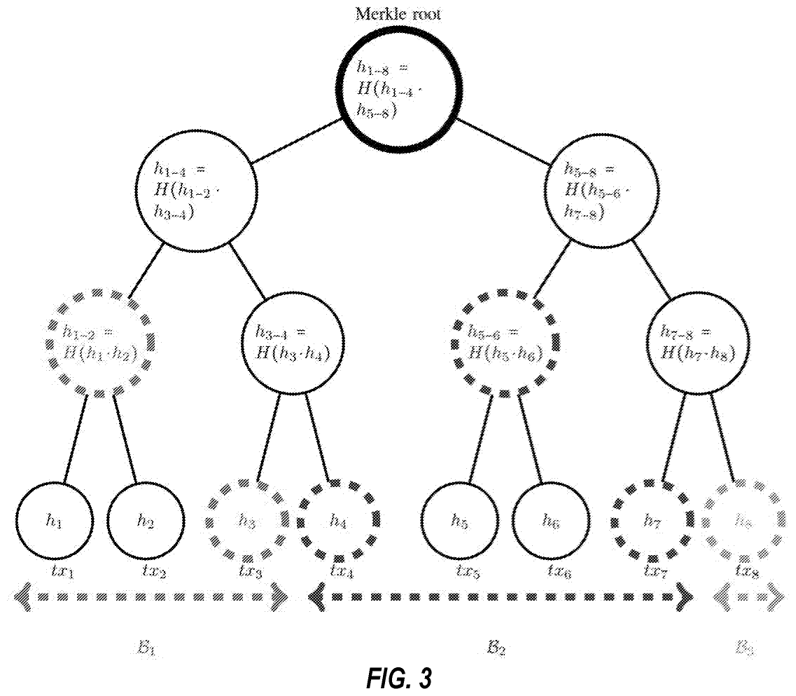

Example 4: Let B={tx₁, . . . tx₈} be a block of b=8 transactions with a partition B₁={tx₁, . . . , tx₃}, B₂={tx₄, . . . tx₇}, B₃={tx₈}, into three segments as illustrated in FIG. 3. The partition proof μ={P₁, P₂, P₃ }={{h₁₋₂, h₃}, {h₄, h₅₋₆, h₇}, h₈} has three lists of hash values that correspond to the subtrees in each segment. For instance, segment B₂ corresponds to three subtrees: The first with tx₄, the second with tx₅ and tx₆ and the third with tx₇. Note that, in certain implementations, any two of these subtrees cannot be merged to a larger subtree because then transactions of other segments will be included as well. In the validation process, the second committee receives B₂ and μ. It first validates P₂ in μ by calculating based on the transactions of B₂ the values of h₄, h₅₋₆, h₇ and compares them to those in P₂. In addition, it calculates the Merkle root for the complete tree h₁₋₈ based on the hash values in P₁, P₂, P₃ such that h₁₋₈=H(h₁₋₄·h₅₋₈)=H(H(h₁₋₂·h₃₋₄)·H(h₅₋₆·h₇₋₈))=H(H(h₁₋₂·H(h₃·h₄))·H(h₅₋₆·H(h₇·h₈))) where all input values are given explicitly in the partition proof μ.

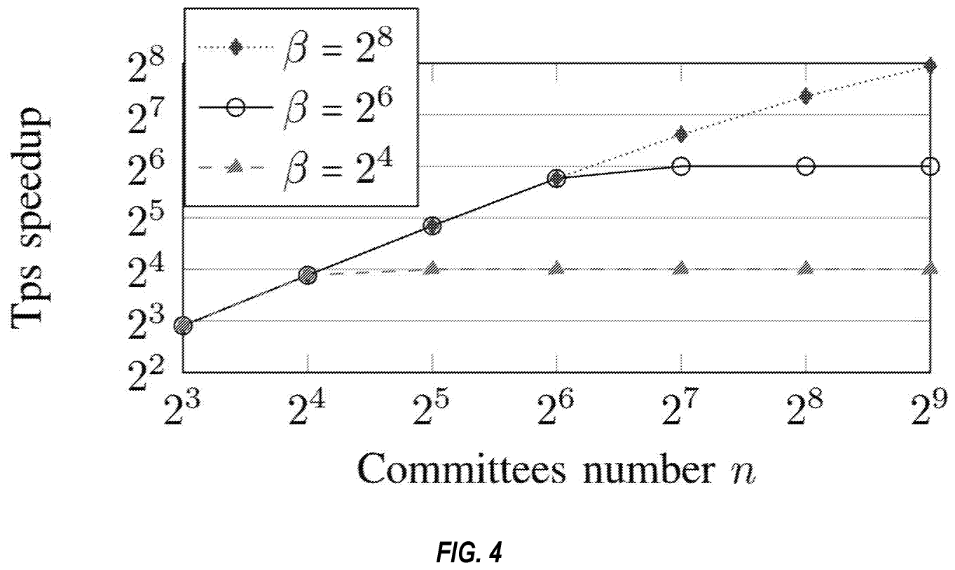

As noted, FIG. 3 illustrates aspects of the referenced partition proof, such as a Merkle tree for block B with partition to three segments B₁={Δtx₁, . . . , tx₃}, B₂={tx₄, . . . tx₇}, B₃={tx₈}. The partition proof μ={P₁, P₂, P₃} has three lists of hash values (roots) P₁={h₁₋₂, h₃}, P₂={h₄, h₅₋₆, h₇} and P₃={h₈} such that |P₁|=2, |P₂|=3 and |P₃|=1. Dashed circles refer to hash values included in μ. The partition proof is verified by an executor using its corresponding segment transactions and the lists of hash values for other segments given in the proof. Additionally, FIG. 4 illustrates the impact of the acceleration factor β and the committees number n.

We assume an application where T_{φ}^{E} is the dominant factor compared to δ_{sig}, δₚₐᵣₜ and δ_{H} (defined herein) since it requires state access and non-trivial code execution. Hence, in our analysis we assume δ_{H}≤T_{φ}^{E}/k_{H}, δₚₐᵣₜ≤T_{φ}^{E}/kₚₐᵣₜ and δ_{sig}≤T_{φ}^{E}/k_{sig} where k_{H}, kₚₐᵣₜ and k_{sig} are fixed constants. These constants may be increased by using a hashing scheme that supports parallel computation, such as Merkle hashing, and by parallelizing signature verification.

Using the above notation, in the base protocol, the total term time is

$${T}^{B} = {T}_{φ}^{E} \cdot {b}_{ma x} + c \cdot \frac{{T}_{\text{?}}^{g}}{k} \text{?} + δ = {T}_{E φ} \cdot {b}_{ma x} \cdot ( 1 + \text{?} \cdot {b}_{ma x} ) + δ . \\ \text{?} \text{indicates text missing or illegible when filed}$$

When the size of bₘₐₓ is moderately large we can neglect δ as it does not grow with bₘₐₓ and get that the term time is approximately T^{B}≈T_{φ}^{E}·bₘₐₓ.

We denote T ps^{A} as the accelerated protocol throughput. As the accelerator starts the execution of the next block once it completes the execution of the current one, the accelerator and executors operate in a pipeline, hence the T ps^{A}=b [symbol] _{max(T}_{^{AP}}_{,T}_{^{EP}}₎. For large bₘₐₓ we neglect the parameters that do not scale with bₘₐₓ, getting

$${Tps}^{A} \approx \text{?} \cdot min ( β , \text{?} ) . \\ \text{?} \text{indicates text missing or illegible when filed}$$

In FIG. 4 we compare the throughput of the accelerated protocol, T ps^{A}, with the throughput of a sequential execution by a single executor

$$\text{?} \approx \text{?} . \\ \text{?} \text{indicates text missing or illegible when filed}$$

We use k_{H}=500 based on analysis of the transaction processing and execution time and SHA256 hash calculation time of a single state update, as performed by a typical transaction and γ=1.05. We note, that increasing n beyond β·γ does not provide additional speedup.

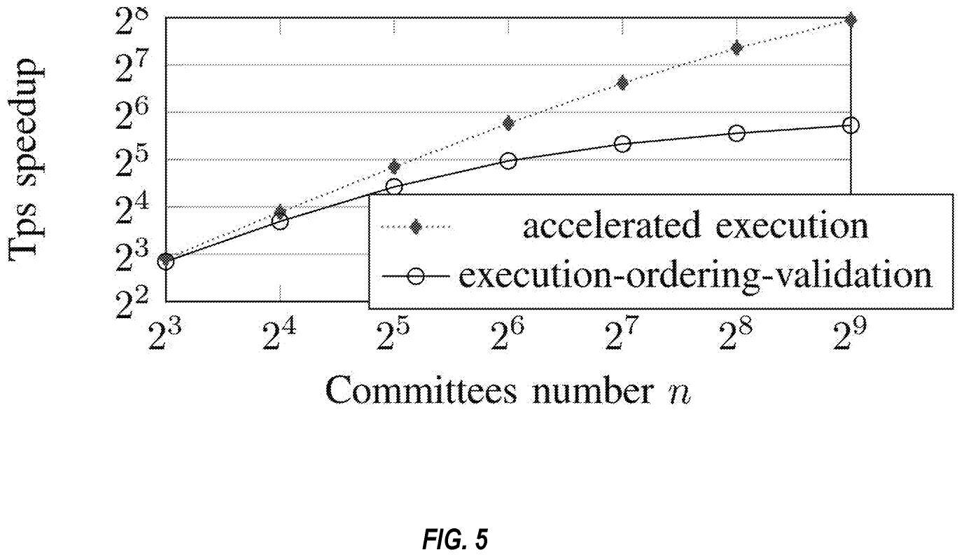

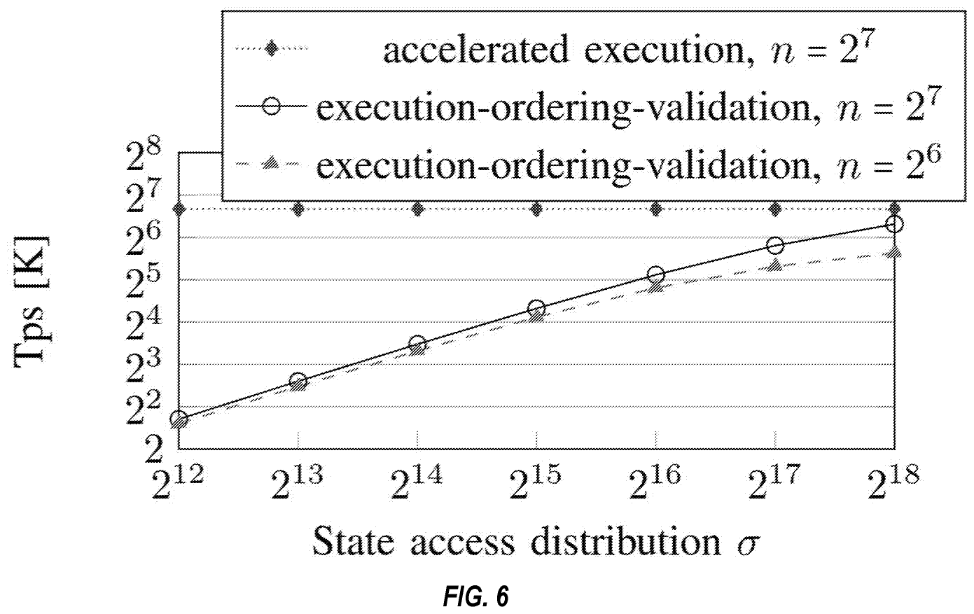

In FIG. 5 and FIG. 6 we compare the performance of our protocol (with k_{H}=500, γ=1.05) to an execution-ordering-validation approach with execution performed by n committees of executors. We assume an execution of 5000 transaction per committee before a state update (corresponds to 5 sec·1000 T ps, where 5 seconds is an estimation of the time of execution, ordering and validation). We model the state access distribution as normal distribution N(μ, σ), namely state index i is accessed by a transaction with probability

$${\int }_{i}^{i + 1} \text{?}$$

$$\text{?} \text{indicates text missing or illegible when filed}$$

exp

$$\frac{{( x - u )}^{2}}{2 {δ}^{2}} dx .$$

In FIG. 5 we assume σ=10⁶ and examine the impact of n. As the level of concurrency n increases, the probability of state conflicts resulting in transaction abortion increases, limiting the ability to scale to large n. In FIG. 6 we analyze how the performance of the two approaches depends on the transaction content. We set n=128 and evaluate the number of transactions per second (Tps). While, in certain implementations, the transaction content does not necessarily impact the performance of the accelerated execution approach, with execution-ordering-validation, the effective throughput is significantly reduced as the number of collisions increases. We note that for σ<2¹⁵, doubling the number of parallel committees has a little impact on the speedup.

As shown in FIGS. 1A-1B and described in detail herein, the described technologies can be implemented with respect to systems, methods, and related technologies for scaling decentralized systems/blockchain execution and storage.

For example, it can be appreciated that sequential transaction execution can be challenging to scale using concurrent computation. This can be even more challenging in a decentralized system, where nodes can behave maliciously.

In certain implementations, in scenarios where execution is performed by all nodes, resources and in particular ones that may be required for high throughput execution may need to be allocated in all nodes.

Accordingly, as described herein, the described technologies can be configured to utilize a relatively small number of performance enhancers—e.g., high performance (compute, storage, network) node(s) 130, that are likely to operate as a distributed system over multiple cores, servers, accelerators, etc.

Achieving consensus on the ordering of transaction (e.g., via ordering shards 120) prior to the execution can prevent manipulation of the ordering, front lining or censorship by the high-performance node(s) 130.

In certain implementations, the referenced performance enhancer (e.g., accelerator 130) can execute the entire “block of transactions” (190), e.g., to provide the required data or hints to the execution shards 140 to execute and achieve consensus on their shard. Further features include:

Relevant read data (input state) (160), e.g., based on the pre-block state, based on the execution results of previous shards, etc.

In a sharded storage scheme, the pre-block initialized state can be verified by a set of data storage shards (e.g., data storage shards 150 as shown in FIG. 1A) that may hold only part of storage.

Alternatively, in certain implementations the storage correctness may be proven by proofs such as Merkle proof.

The described technologies thereby enable a separation of the data storing and execution as the executor (e.g., execution shard 140/execution node 142) may receive the relevant state from the performance enhancer 130.

In certain implementations, the executors may also hold the entire or part of the state. Alternatively, the accelerator can hold the state and can provide proof to the executors, as described herein.

When the performance enhancer 130 is faulty or malicious, the state can be detected by the executors which can remove the malicious performance enhancer.

If no valid performance enhancer is present, the described technologies can transition to a base protocol, operating in their normal performance.

Incentives (such as stake) may be used to incentivize enhancers to operate correctly.

The transactions may be sent to the different shards directly, or by the performance enhancer.

Additionally, in certain implementations the described technologies can support or implement a mode where the enhancer optimizes the transactions partitioning (for example divide to non-uniform segments if the transactions complexity or shards are not uniform).

By way of further illustration, as depicted in FIGS. 1A-1B and described in detail herein, in certain implementations the described technologies can be implemented with respect to a sharded ordering consensus (e.g., with respect to ordering shards 120). For example, in an ordering before validation scheme, ordering consensus sharding can be relatively simple as there's dependency among the shards.

Transactions (e.g., of all the transaction segments) can be executed by a performance enhancer (e.g., accelerator 130). The performance enhancer may be comprised of a distributed system of multiple strong machines with high bandwidth interfaces.

It can be appreciated that by solving a distributed problem instead of decentralized problem simplifies it and enables the described technologies to use described techniques and operations for parallel execution such as speculative execution or heuristics based on the smart contracts.

In certain implementations, one or more performance enhancers can be instantiated within a network. If a performance enhancer is detected as faulty or malicious, it can be ignored and removed from the network. In certain implementations, when no performance enhancer is present, the platform continues to operate regularly on a single shard capacity.

The transactions can be partitioned to shards according to their order—for example transactions 1-1000, 1001-2000, 2001-3000, etc. Further example of such partitioning or dividing is depicted in FIG. 1B (showing block 190 divided into transaction segment 170A, 170B, etc.). The performance enhancer can send to each execution shard 140 the state update 160 that results from the previous shards execution. This allows each shard to validate only the relevant transactions and operate in parallel to other shards.

Each shard can validate the execution and sign the result assuming the correctness of the input state. Each shard provides a proof to next shard that the input state update that was provided as a hint by the performance enhancer is valid, thus validating the entire state update.

The updated state along with the proofs can be sent to the data nodes for update.

In certain implementations, if the state is sharded, each of the data nodes 150 may maintain only the portion of the state that is under its responsibility.

Moreover, in certain implementations the described technologies can be configured such clients 110 send transactions directly to the accelerator 130 (or a set of accelerators) which can implement the ordering functionality (e.g., without ordering shards 120).

Additionally, in certain implementations the described technologies can be configured such that accelerator 130 (or a set of accelerators) send the validators 140 the state while holding back parts of it, e.g., in order to keep the state private from the validators while providing the validators a zero-knowledge proof for the missing data processing.

Moreover, in certain implementations the described technologies can be configured such the clients 110 send transactions directly to the accelerator 130 that holds their private data or state. The accelerator holds back the private data from the validators 140 and provides them with a zero-knowledge proof for the missing data processing.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

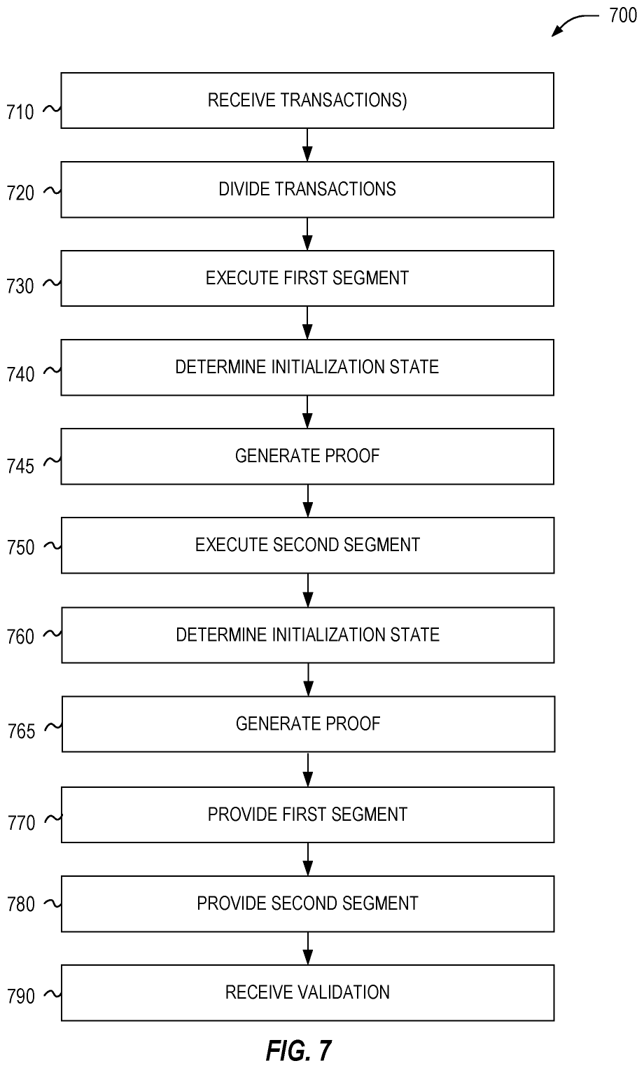

FIG. 7 is a flow chart illustrating a method 700, according to an example embodiment, for scaling and accelerating decentralized execution of transactions. The method is performed by processing logic that can comprise hardware (circuitry, dedicated logic, etc.), software (such as is run on a computing device such as those described herein), or a combination of both. In one implementation, the method 700 is performed by one or more elements depicted and/or described in relation to FIGS. 1A-1B (including but not limited to accelerator 130, one or more applications or modules executing thereon), while in some other implementations, the one or more blocks of FIG. 7 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 710, a set or block 190 of transactions is received (e.g., from client(s) 110, ordering shard(s) 120, and/or ordering node(s) 122, etc., as described herein). In certain implementations, such transactions can be received by an accelerator node 130, e.g., within a decentralized network 100, as described herein. In certain implementations, such a set of transactions can include an ordered set of transactions. Moreover, in certain implementations such a set or transactions can be received from one or more ordering nodes 120 (e.g., as shown in FIG. 1A).

At operation 720, the set or block 190 of transactions (e.g., as received at 710) can be divided or partitioned. In certain implementations, such transactions can be divided into a first transaction segment, a second transaction segment, etc. (e.g., into any number of segments), as described herein. For example, FIG. 1B depicts set or block of transactions 190 being divided into transaction segments 170A, 170B, etc. Additionally, in certain implementations a proof such as a partition proof can be computed, e.g., with respect to the divided segment(s).

At operation 730, the first transaction segment can be executed. In certain implementations, such a segment can be executed such that the output of the execution of the first transaction segment validates the initialization state for the second segment, as described in detail herein.

At operation 740, a relevant initialization state 160 for the first transaction segment can be determined. In certain implementations, such a relevant initialization state can be determined based on the execution of the first transaction segment, as described herein. For example, as shown in FIG. 1B, initialization state 160A can be generated based on execution of transaction segment 170A.

At operation 745, a proof is generated. In certain implementations, such a proof (e.g., proof 180A as shown in FIG. 1B and described herein) can be generated with respect to the first initialization state, as described herein.

At operation 750, the second transaction segment (e.g. as partitioned at 720) is executed. In certain implementations, such a transaction segment (e.g., segment 170B as shown in FIG. 1B) can be executed based on the execution of the first transaction segment (e.g., segment 170A). It should be understood that the described process(es) can be repeated with respect to any number of additional segments. Additionally, in certain implementations the output of the execution of the second transaction segment validates a post-execution state of the set of transactions (e.g., output 180C as shown in FIG. 1B), as described herein.

At operation 760, a second initialization state is determined. In certain implementations, such an initialization state can be determined based on/in view of the execution of the second transaction segment (e.g., at 750) and/or an output of the execution of the first transaction segment (e.g., at 730), as described herein.

At operation 765, a proof of the second initialization state can be generated, as described herein.

At operation 770, the first transaction segment and the first initialization state can be provided, e.g., to a first execution shard (e.g., execution shard 140A as shown in FIG. 1B) within the decentralized network. Additionally, in certain implementations the first transaction segment, the first initialization state, and the proof of the first initialization state can be provided to a first execution shard within the decentralized network, as described herein.

Moreover, in certain implementations a proof such as a zero-knowledge proof can be computed, e.g., based on a portion of the first transaction segment and a portion of the first initialization stale. In certain implementations, such a zero-knowledge proof can be provided to the first execution shard, e.g., in lieu of the portion of the first transaction segment based upon which the zero-knowledge proof was computed.

At operation 780, the second transaction segment and the second initialization state can be provided, e.g., to a second execution shard within the decentralized network, as described in detail herein. In certain implementations, the second transaction segment, the second initialization state, and the proof of the second initialization state can be provided to a second execution shard within the decentralized network.

Moreover, in certain implementations a proof such as a zero-knowledge proof can be computed, e.g., based on a portion of the second transaction segment and a portion of the second initialization state. Such a zero-knowledge proof can be provided to the second execution shard, e.g., in lieu of the portion of the second transaction segment based upon which the zero-knowledge proof was computed.

At operation 790, a validation of one or more results of the set/block of transactions can be received. In certain implementations, such a validation of the one or more results can be computed within the decentralized network, e.g., based an output of the execution of the first transaction segment (e.g., segment 170A as shown in FIG. 1B) by the first execution shard (e.g., shard 140A) and an output of the execution of the second transaction segment (170B) by the second execution shard (140B) (together with outputs of the execution of other segment(s) that make up the set of transactions). Moreover, in certain implementations the second initialization state can be validated within the decentralized network based on the validation of the first initialization state, e.g., as described in detail herein. Additionally, in certain implementations the described technologies can be configured to implement one or more of the described operations as method(s) that execute on one or more of the execution node(s) and/or execution shards, as described herein.

It can therefore be appreciated that the described technologies are directed to and address specific technical challenges and longstanding deficiencies in multiple technical areas, including but not limited to cryptography, cybersecurity, and distributed and decentralized systems. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

It should also be noted that while the technologies described herein are illustrated primarily with respect to accelerating decentralized execution of transactions, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) cats be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different tines, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

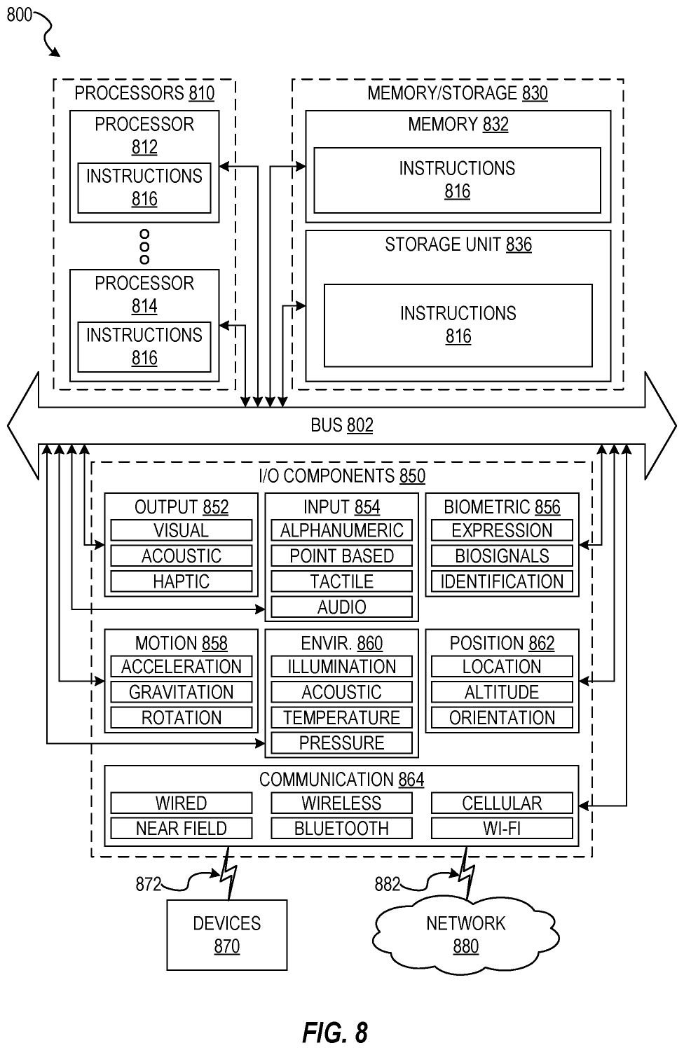

FIG. 8 is a block diagram illustrating components of a machine 800, according to some example implementations, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein can be executed. The instructions 816 transform the general, non-programmed machine into a particular machine programmed to carry out the described and illustrated functions in the manner described. In alternative implementations, the machine 800 operates as a standalone device or can be coupled (e.g., networked) to other machines. In a networked deployment, the machine 800 can operate in the capacity of a server machine or a client machine in a server-client network environment, or as a peer machine in a peer-to-peer (or distributed) network environment. The machine 800 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 can include processors 810, memory/storage 830, and I/O components 850, which can be configured to communicate with each other such as via a bus 802. In an example implementation, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 812 and a processor 814 that can execute the instructions 816. The term “processor” is intended to include multi-core processors that can comprise two or more independent processors (sometimes referred to as “cores”) that can execute instructions contemporaneously. Although FIG. 8 shows multiple processors 810, the machine 800 can include a single processor with a single core, a single processor with multiple cores (e.g., a multi-core processor), multiple processors with a single core, multiple processors with multiples cores, or any combination thereof.

The memory/storage 830 can include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 can also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions (e.g., instructions 816) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine (e.g., processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 can include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 can include many other components that are not shown in FIG. 8. The I/O components 850 are grouped according to functionality merely for simplifying the following discussion and the grouping is in no way limiting. In various example implementations, the I/O components 850 can include output components 852 and input components 854. The output components 852 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 850 can include biometric components 856, motion components 858, environmental components 860, or position components 862, among a wide array of other components. For example, the biometric components 856 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 can include acceleration sensor components (e.g., accelerometer), gravitation sensor components, rotation sensor components (e.g., gyroscope), and so forth. The environmental components 860 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 862 can include location sensor components (e.g., a Global Position System (GPS) receiver component), altitude sensor components (e.g., altimeters or barometers that detect air pressure from which altitude can be derived), orientation sensor components (e. g, magnetometers), and the like.

Communication can be implemented using a wide variety of technologies. The I/O components 850 can include communication components 864 operable to couple the machine 800 to a network 880 or devices 870 via a coupling 882 and a coupling 872, respectively. For example, the communication components 864 can include a network interface component or other suitable device to interface with the network 880. In further examples, the communication components 864 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 can be another machine or any of a wide variety of peripheral devices (e.g., a peripheral device coupled via a USB).

Moreover, the communication components 864 can detect identifiers or include components operable to detect identifiers. For example, the communication components 864 can include Radio Frequency Identification (RFID) tag reader components, NFC smart tag detection components, optical reader components (e. g, an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 864, such as location via Internet Protocol (IP) geolocation, location via Wi-Fi® signal triangulation, location via detecting an NFC beacon signal that can indicate a particular location, and so forth.

In various example implementations, one or more portions of the network 880 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 can include a wireless or cellular network and the coupling 882 can be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 8G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 can be transmitted or received over the network 880 using a transmission medium via a network interface device (e.g., a network interface component included in the communication components 864) and utilizing any one of a number of well-known transfer protocols (e.g., HTTP). Similarly, the instructions 816 can be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving, by an accelerator node within a decentralized network, a set of transactions;
dividing the set of transactions into a first transaction segment and a second transaction segment;
executing the first transaction segment;
based on the execution of the first transaction segment, determining a relevant initialization state for the first transaction segment;
executing the second transaction segment based on the execution of the first transaction segment;
based on (a) the execution of the second transaction segment and (b) an output of the execution of the first transaction segment, determining a second initialization state;
providing, to a first execution shard within the decentralized network, the first transaction segment and the first initialization state;
providing, to a second execution shard within the decentralized network, the second transaction segment and the second initialization state; and
receiving a validation of one or more results of the set of transactions, wherein the validation of the one or more results is computed within the decentralized network based an output of the execution of the first transaction segment by the first execution shard and an output of the execution of the second transaction segment by the second execution shard.

2. The system of claim 1, wherein the set of transaction comprises an ordered set of transactions.

3. The system of claim 1, wherein receiving a set of transactions comprises receiving the set of transactions from one or more ordering nodes.

4. The system of claim 1, wherein dividing the ordered set of transactions comprises computing a partition proof with respect to the first transaction segment and the second transaction segment.

5. The system of claim 1, wherein the memory further stores instructions to cause the system to perform operations comprising generating a proof of the first initialization state.

6. The system of claim 5, wherein providing the first transaction segment comprises providing, to a first execution shard within the decentralized network, the first transaction segment, the first initialization state, and the proof of the first initialization state.

7. The system of claim 1, wherein the memory further stores instructions to cause the system to perform operations comprising generating a proof of the second initialization state.

8. The system of claim 7, wherein providing the second transaction segment comprises providing, to a second execution shard within the decentralized network, the second transaction segment, the second initialization state, and the proof of the second initialization state.

9. The system of claim 1, wherein the second initialization state is validated within the decentralized network based on the validation of the first initialization state.

10. The system of claim 1, wherein the output of the execution of the first transaction segment validates the initialization state for the second segment.

11. The system of claim 1, wherein the output of the execution of the second transaction segment validates a post-execution state of the set of transactions.

12. The system of claim 1, wherein providing the first transaction segment and initialization state comprises:
computing a zero-knowledge proof based on a portion of the first transaction segment and a portion of the first initialization state; and
providing the zero-knowledge proof to the first execution shard in lieu of the portion of the first transaction segment based upon which the zero-knowledge proof was computed.

13. The system of claim 1, wherein providing the second transaction segment and initialization state comprises:
computing a zero-knowledge proof based on a portion of the second transaction segment and a portion of the second initialization state; and
providing the zero-knowledge proof to the second execution shard in lieu of the portion of the second transaction segment based upon which the zero-knowledge proof was computed.

14. A method comprising:
receiving, by an accelerator node within a decentralized network, a set of transactions;
dividing the set of transactions into a first transaction segment and a second transaction segment;
executing the first transaction segment;
based on the execution of the first transaction segment, determining a relevant initialization state for the first transaction segment;
executing the second transaction segment based on the execution of the first transaction segment;
based on (a) the execution of the second transaction segment and (b) an output of the execution of the first transaction segment, determining a second initialization state;
providing, to a first execution shard within the decentralized network, the first transaction segment and the first initialization state;
providing, to a second execution shard within the decentralized network, the second transaction segment and the second initialization state; and
receiving a validation of one or more results of the set of transactions, wherein the validation of the one or more results is computed within the decentralized network based an output of the execution of the first transaction segment by the first execution shard and an output of the execution of the second transaction segment by the second execution shard.

15. The method of claim 14, wherein the set of transaction comprises an ordered set of transactions.

16. The method of claim 14, wherein receiving a set of transactions comprises receiving the set of transactions from one or more ordering nodes.

17. The method of claim 14, wherein dividing the ordered set of transactions comprises computing a partition proof with respect to the first transaction segment and the second transaction segment.

18. The method of claim 14, further comprising generating a proof of the first initialization state.

19. The method of claim 18, wherein providing the first transaction segment comprises providing, to a first execution shard within the decentralized network, the first transaction segment, the first initialization state, and the proof of the first initialization state.

20. The method of claim 14, further comprising generating a proof of the second initialization state.

21. The method of claim 20, wherein providing the second transaction segment comprises providing, to a second execution shard within the decentralized network, the second transaction segment, the second initialization state, and the proof of the second initialization state.

22. The method of claim 14, wherein the second initialization state is validated within the decentralized network based on the validation of the first initialization state.

23. The method of claim 14, wherein the output of the execution of the first transaction segment validates the initialization state for the second segment.

24. The method of claim 14, wherein the output of the execution of the second transaction segment validates a post-execution state of the set of transactions.

25. The method of claim 14, wherein providing the first transaction segment and initialization state comprises:
computing a zero-knowledge proof based on a portion of the first transaction segment and a portion of the first initialization state; and
providing the zero-knowledge proof to the first execution shard in lieu of the portion of the first transaction segment based upon which the zero-knowledge proof was computed.

26. The method of claim 14, wherein providing the second transaction segment and initialization state comprises:
computing a zero-knowledge proof based on a portion of the second transaction segment and a portion of the second initialization state; and
providing the zero-knowledge proof to the second execution shard in lieu of the portion of the second transaction segment based upon which the zero-knowledge proof was computed.

27. A non-transitory computer readable medium having instructions stored thereon that, when executed by a processing device, cause the processing device to perform operations comprising
receiving, by an accelerator node within a decentralized network, a set of transactions;
dividing the set of transactions into a first transaction segment and a second transaction segment;
executing the first transaction segment;
based on the execution of the first transaction segment, determining a relevant initialization state for the first transaction segment;
executing the second transaction segment based on the execution of the first transaction segment;
based on (a) the execution of the second transaction segment and (b) an output of the execution of the first transaction segment, determining a second initialization state;
providing, to a first execution shard within the decentralized network, the first transaction segment and the first initialization state;
providing, to a second execution shard within the decentralized network, the second transaction segment and the second initialization state; and
receiving a validation of one or more results of the set of transactions, wherein the validation of the one or more results is computed within the decentralized network based an output of the execution of the first transaction segment by the first execution shard and an output of the execution of the second transaction segment by the second execution shard.
